(19) United States
(12) Patent Application Publication
(10) Pub. No.: US 2026/0141571 A1
(43) Pub. Date: May 21, 2026

(54) MEDIA DATA GENERATION IN ASSOCATION WITH A GENERATIVE MODEL AND AN ADAPTER

(71) Applicant: QUALCOMM Incorporated, San Diego, CA (US)

(72) Inventors: Noor Fathima Khanum MOHAMED GHOUSE, Amsterdam (NL); Amir GHODRATI, Amsterdam (NL); Amirhossein HABIBIAN, Amsterdam (NL); Denis KORZHENKOV, Amsterdam (NL)

(21) Appl. No.: 18/948,902

(22) Filed: Nov. 15, 2024

(51) Int. Cl. G06T 11/00

(52) U.S. Cl. CPC G06T 11/00

(57) ABSTRACT

A device includes one or more processors coupled to a memory that is configured to store an adapter and a generative model including multiple layers. The one or more processors are configured to, for a first sampling operation of multiple sampling operations and based on an input image frame, perform a first portion of the first sampling operation via a first set of layers of the multiple layers. The first set of layers includes a first layer associated with a first resolution. The one or more processors are also configured to, for the first sampling operation and based on the input image frame, perform a second portion of the first sampling operation via the adapter. The adapter is associated with a second resolution that is different from the first resolution. The one or more processors are further configured to output, based on the multiple sampling operations, an output image frame.

### I. FIELD

The present disclosure is generally related to generation of media data associated with a generative model, and more particularly, to generating media data based on a generative model and an adapter.

### II. DESCRIPTION OF RELATED ART

Advances in technology have resulted in smaller and more powerful computing devices. In artificial intelligence (AI), generative models have been used in computer vision, audio, reinforcement learning, and computational biology. For example, with reference to computer vision applications, generative models, such as diffusion models, can be used for a variety of tasks or operations, such as image denoising, inpainting, super-resolution, image generation, and video generation. As another example, in other applications, generative models (e.g., diffusion models) have been applied to natural language processing task or operations, such as text generation and summarization, sound generation, and reinforcement learning. The generative models may have a variety of architectures, such as a U-Net architecture or a transformer architecture.

Typically, video generative models (e.g., generative video diffusion models), such as image-to-video generative models, are built by adding temporal modules to an image model structure (e.g., an image generation backbone). The temporal modules, such as temporal residual block (resblock) modules or temporal transformer modules, are added to model temporal correlations. The temporal modules added to the image model structure to create a video model (e.g., an image-to-video generative model) impose a significant computational cost and parameter cost to the image generation structure.

### III. SUMMARY

According to one implementation of the present disclosure, a device includes a memory configured to store an adapter and a generative model including multiple layers. The device also includes one or more processors configured to obtain an input image frame. The one or more processors are also configured to, for a first sampling operation of multiple sampling operations and based on the input image frame, perform a first portion of the first sampling operation via a first set of one or more layers of the multiple layers of the generative model. The first set of one or more layers includes a first layer associated with a first resolution. The one or more processors are also configured to, for the first sampling operation of the multiple sampling operations and based on the input image frame, perform a second portion of the first sampling operation via the adapter. The adapter is associated with a second resolution that is different from the first resolution. The one or more processors are also configured to output, based on the multiple sampling operations, one or more output image frames.

According to another implementation of the present disclosure, a method of operating a device having a processor includes obtaining an input image frame. The method also includes, for a first sampling operation of multiple sampling operations and based on the input image frame, performing a first portion of the first sampling operation via a first set of one or more layers of multiple layers of a generative model. The first set of one or more layers includes a first layer associated with a first resolution. The method further includes, for the first sampling operation of the multiple sampling operations and based on the input image frame, performing a second portion of the first sampling operation via an adapter. The adapter is associated with a second resolution that is different from the first resolution. The method further includes outputting, based on the multiple sampling operations, one or more output image frames.

According to another implementation of the present disclosure, a non-transitory computer-readable medium stores instructions that are executable by one or more processors to cause the one or more processors to obtain an input image frame. The instructions further cause the one or more processors to, for a first sampling operation of multiple sampling operations and based on the input image frame, perform a first portion of the first sampling operation via a first set of one or more layers of multiple layers of a generative model. The first set of one or more layers includes a first layer associated with a first resolution. The instructions further cause the one or more processors to, for the first sampling operation of the multiple sampling operations and based on the input image frame, perform a second portion of the first sampling operation via an adapter. The adapter is associated with a second resolution that is different from the first resolution. The instructions also cause the one or more processors to output, based on the multiple sampling operations, one or more output image frames.

According to another implementation of the present disclosure, an apparatus includes means for obtaining an input image frame. The apparatus further includes means for performing, for a first sampling operation of multiple sampling operations and based on the input image frame, a first portion of the first sampling operation via a first set of one or more layers of multiple layers of a generative model. The first set of one or more layers includes a first layer associated with a first resolution. The apparatus further includes means for performing, for the first sampling operation of the multiple sampling operations and based on the input image frame, a second portion of the first sampling operation via an adapter. The adapter is associated with a second resolution that is different from the first resolution. The apparatus further includes means for outputting, based on the multiple sampling operations, one or more output image frames.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system to generate media data, in accordance with one or more aspects of the present disclosure.

FIG. 2 is a diagram of examples of models of the system of FIG. 1, in accordance with some examples of the present disclosure.

FIG. 3 is a block diagram to illustrate an example of an adapter of the system of FIG. 1, in accordance with one or more aspects of the present disclosure.

FIG. 4 is a diagram to illustrate an example of multiple sampling steps associated with generation of media data, in accordance with some examples of the present disclosure.

FIG. 5 is a diagram to illustrate an example of multiple sampling steps associated with generation of media data, in accordance with some examples of the present disclosure.

FIG. 6 is a block diagram of a particular illustrative aspect of a system that is operable to generate media data, in accordance with some examples of the present disclosure.

FIG. 7 is a diagram of an example of an integrated circuit operable to generate media data, in accordance with some examples of the present disclosure.

FIG. 8 is a diagram of a mobile device operable to generate media data, in accordance with some examples of the present disclosure.

FIG. 9 is a diagram of a wearable electronic device operable to generate media data, in accordance with some examples of the present disclosure.

FIG. 10 is a diagram of a voice-controlled speaker system operable to generate media data, in accordance with some examples of the present disclosure.

FIG. 11 is a diagram of a camera operable to generate media data, in accordance with some examples of the present disclosure.

FIG. 12 is a diagram of a headset, such as a virtual reality, mixed reality, or augmented reality headset, operable to generate media data, in accordance with some examples of the present disclosure.

FIG. 13 is a diagram of a mixed reality or augmented reality glasses device operable to generate media data, in accordance with some examples of the present disclosure.

FIG. 14 is a diagram of an example of a vehicle operable to generate media data, in accordance with some examples of the present disclosure.

FIG. 15 is a diagram of an example of a method of generating media data, in accordance with some aspects of the present disclosure.

FIG. 16 is a block diagram of an illustrative example of a device that is operable to generate media data, in accordance with one or more aspects of the present disclosure.

### V. DETAILED DESCRIPTION

The above-described problems associated with use of generative models are solved using a portion of a generative model (e.g., an image-to-video generative model) and an adapter during at least one sampling operation of multiple sampling operations as described herein. The present disclosure provides systems, devices, apparatus, methods, and computer-readable media for performing multiple sampling operations (e.g., multiple sampling steps) in which a first sampling operation uses a generative model and a second sampling operation uses a portion of the generative model and an adapter. The generative model (e.g., a first generative model) includes multiple layers. The multiple layers include a first set of one or more layers having a first layer associated with a first resolution, and a second set of one or more layers having a second layer that is associated with a second resolution that is a lower resolution than the first layer. In some embodiments, the generative model has a U-Net architecture. A modified generative model (e.g., a second generative model) may include the first set of one or more layers of the generative model, and an adapter. The adapter is associated with the second resolution and is configured to approximate operation of the second set of one or more layers of the multiple layers of the generative model. In some embodiments, the modified generative model (e.g., the second generative model) is a modified version of the generative model (e.g., the first generative model).

In some aspects, a device (e.g., a media generator) is configured to perform the multiple sampling operations (e.g., multiple sampling steps) based on an input image frame. The media generator (including a denoiser) performs a first sampling operation (of the multiple sampling operations) based on the generative model (e.g., the first generative model). Additionally, the media generator (e.g., the denoiser) also performs a second sampling operation (of the multiple sampling operations) based on the modified generative model (e.g., the second generative model that includes the adapter). The device is configured to output one or more output image frames, such as a series of image frames of video content, based on the multiple sampling operations.

Particular implementations of the subject matter described in this disclosure can be implemented to realize one or more of the following potential advantages. In some aspects, the present disclosure provides techniques for performing video diffusion in which at least one sampling operation of multiple sampling operations uses a first generative model and at least one other sampling operation of the multiple sampling operations uses a second generative model that includes an adapter. Use of the second generative model (that includes the adapter) can be performed faster and conserve power as compared to conventional techniques which use the same first generative model for all sampling operations of the multiple sampling operations. Additionally, the techniques described herein can perform the multiple sampling operations using the first generative model and the second generative model to generate video data that would otherwise take longer and be more computationally expensive as compared to the conventional techniques. For example, as compared to conventional techniques, the techniques described herein can reduce a cost (e.g., an amount of time and/or power consumption) of video generation by approximately thirty percent with little to no loss in temporal consistency and video quality.

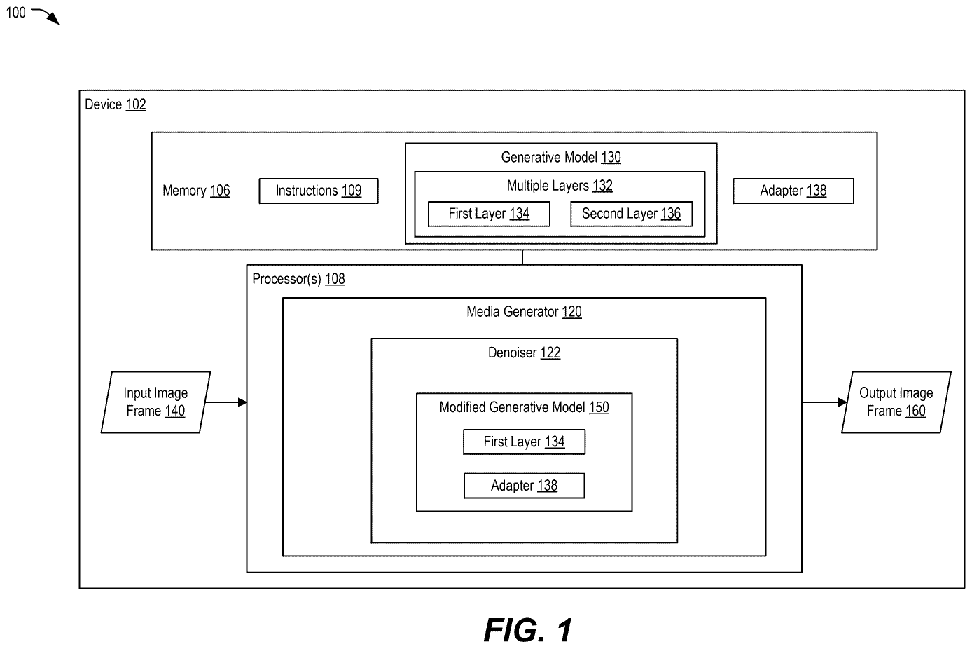

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

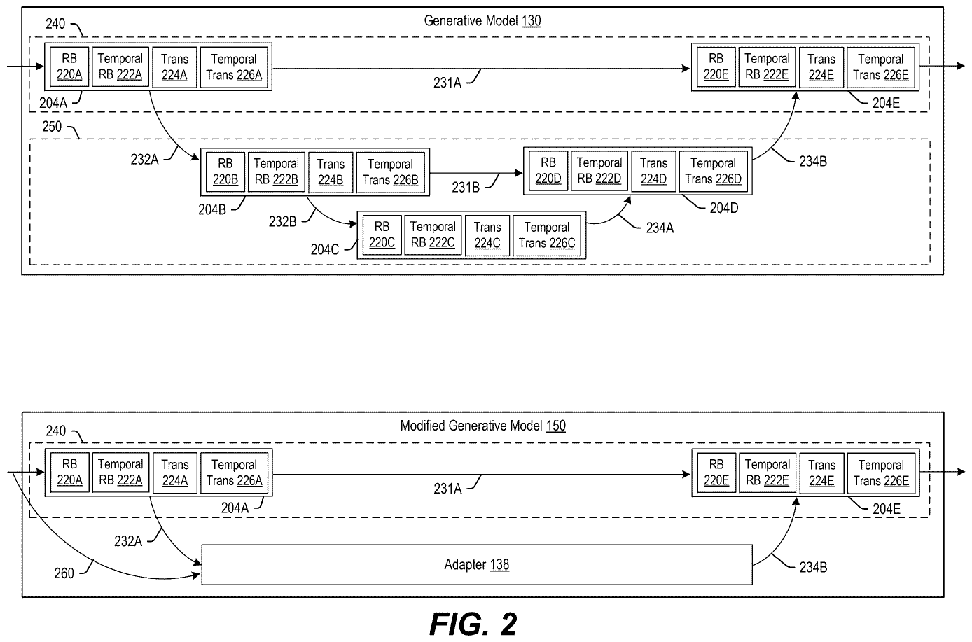

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple blocks are illustrated and associated with reference numbers 204A, 204B, 204C, 204D, and 204E. When referring to a particular one of these blocks, such as a block 204A, the distinguishing letter “A” is used. However, when referring to any arbitrary one of these blocks or to these blocks as a group, the reference number 204 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 to generate media data, in accordance with one or more aspects of the present disclosure. The system 100 includes a device 102 that is configured to or is operable to generate the media data, such as one or more output image frames 160 (referred to herein as the “output image frame 160”).

The device 102 includes a memory 106 and one or more processors 108 (referred to herein as a “processor 108”). The memory 106 may include one or more memories, such as a single memory or multiple different memories (of the same type or of different types). The memory 106 is configured to store instructions 109, a generative model 130, and an adapter 138. The instructions 109, when executed by the processor 108, cause the processor 108 to perform one or more operations as described herein.

The generative model 130 is configured to generate media data, such as image data, video data, audio data, training data, or a combination thereof. In the embodiment shown in FIG. 1, the generative model 130 is an image-to-video generative model and is configured to generate the output image frame 160, such as video data. In some examples, the generative model 130 includes a diffusion model, such as a stable diffusion model. To illustrate, the generative model 130 may be a latent diffusion model that is configured to perform image synthesis in a latent space with a relatively low computational demand as compared to image synthesis performed in a pixel space. In some embodiments, the generative model 130 has a U-Net architecture, as described further herein at least with reference to FIG. 2.

The generative model 130 includes multiple layers 132. The multiple layers 132 include a first layer 134 and a second layer 136. The first layer 134 is associated with a first resolution and the second layer 136 is associated with a second resolution that is a lower resolution than the first resolution. In some embodiments, the generative model 130 (e.g., the multiple layers 132) includes a first set of one or more layers and a second set of one or more layers. The first set of one or more layers includes the first layer 134, and the second set of one or more layers includes the second layer 136. In some embodiments, the multiple layers 132 include the first layer 134, the second layer 136, a third layer, and a fourth layer. In some such embodiments, the first set of one or more layers includes the first layer 134, and the second set of one or more layers includes the second layer 136, the third layer, and the fourth layer. In some other implementations, the multiple layers 132 include the first set of one or more layers, the second set of one or more layers, and a third set of one or more layers, where the third set of one or more layers is associated with a lower resolution than the second set of one or more layers. If the multiple layers include four layers, the first set of one or more layers may include the first layer 134, the second set of one or more layers may include the second layer 136 and the third layer, and the third set of one or more layers may include the fourth layer. In some such implementations, the adapter 138 may be substituted for the second set of one or more layers to generate the modified generative model 150 that includes the first set of one or more layers, and/or the third set of one or more layers.

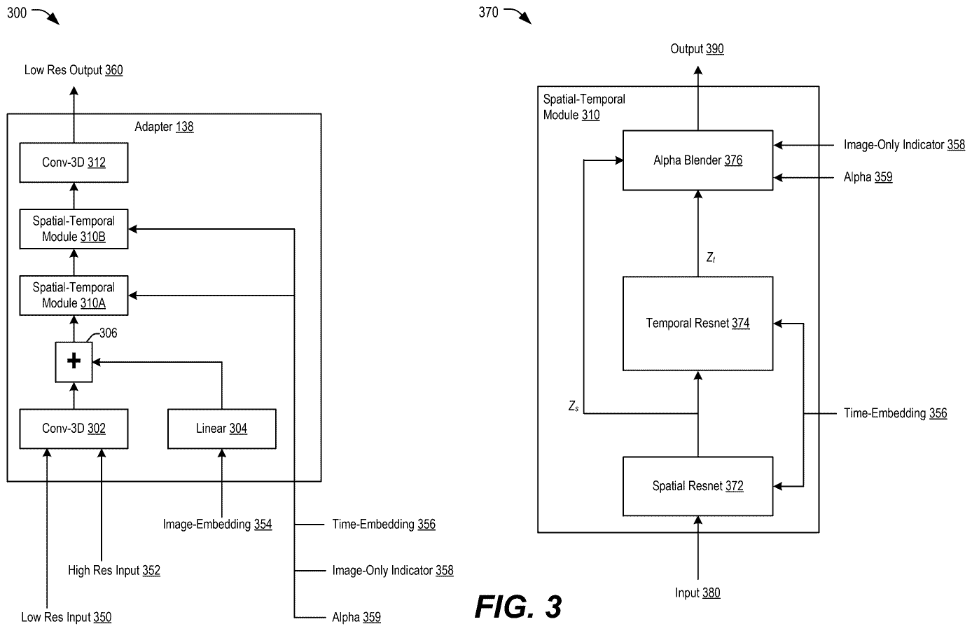

The adapter 138 is configured to approximate operation of one or more layers of the generative model 130, such as the second set of one or more layers of the multiple layers 132 of the generative model 130. In some embodiments, the adapter 138 includes an identity function. In some such embodiments, the adapter 138 is configured to receive a set of one or more features and output the same set of received features. In other embodiments, the adapter 138 is configured to perform one or more convolution functions, such as a two-dimensional (2D) convolutional, a three-dimensional (3D) convolutional function, or a combination thereof, as illustrative, non-limiting examples. An example of the adapter 138 is described further herein at least with reference to FIG. 3.

In some examples, the memory 106 stores other data. The other data may include the media data generated by the processor 108, one or more schemes or patterns for sampling operations (e.g., sampling steps), or a combination thereof. Additionally, or alternatively, in some other examples, the memory 106 also stores one or more additional models, such as a modified generative model 150, as described herein. An example of the modified generative model 150 is described further herein at least with reference to FIG. 2. The modified generative model 150 includes the first set of one or more layers (e.g., the first layer 134) of the multiple layers 132 (of the generative model 130) and the adapter 138. It is noted that the generative model 130 may be referred to herein as a first generative model, and the modified generative model 150 may be referred to herein as a second generative model.

Referring to FIG. 2, FIG. 2 is a diagram of examples of models of the system of FIG. 1, in accordance with some examples of the present disclosure. To illustrate, FIG. 2 includes the generative model 130 (e.g., a diffusion model) and the modified generative model 150. In some embodiments, the media generator 120 generates the modified generative model 150 based on the generative model 130 and the adapter 138. In other embodiments, the device 102 receives the modified generative model 150 and stores the modified generative model 150 at the memory 106.

The generative model 130 may have a U-Net architecture or another architecture. The U-Net architecture is a type of convolution neural network (CNN). The U-Net architecture includes multiple hierarchical layers (e.g., the multiple layers 132). The generative model 130 can include multiple blocks 204. For example, the multiple blocks 204 may include a first block 204A, a second block 204B, a third block 204C, a fourth block 204D, and a fifth block 204E. Although the generative model 130 is described as including five blocks, in other examples, the generative model 130 can include fewer or more than five blocks. The generative model 130 may be arranged in multiple layers, such as a first layer that includes the first block 204A and the fifth block 204E, a second layer that includes the second block 204B and the fourth block 204D, and a third layer that includes the third block 204C.

The U-Net architecture may also be configured to concatenate feature maps from a downsampling path with feature maps from an upsampling path. To illustrate, feature maps output from the first block 204A are downsampled via a first downsample path 232A and provided to the second block 204B, and feature maps output from the second block 204B are downsampled via a second downsample path 232B and provided to the third block 204C. The first block 204A, the first downsample path 232A, the second block 204B, and the second downsample path 232B may correspond to an encoder end (e.g., an encoder portion) of the generative model 130. The third block 204C (e.g., the third layer) may be associated with a bottleneck (e.g., a bottleneck portion) of the generative model 130.

Feature maps output from the third block 204C are upsampled via a first upsample path 234A and provided to the fourth block 204D, and feature maps output from the fourth block 204D are upsampled via a second upsample path 234B and provided to the fifth block 204E. The first upsample path 234A, the fourth block 204D, the second upsample path 234B, and the fifth block 204E may correspond to a decoder end (e.g., a decoder portion) of the generative model 130.

Additionally, the feature maps output by the first block 204A are provided via a first connecting path 231A to the fifth block 204E and concatenated with the feature maps that are received by the fifth block 204E from the fourth block 204D. The feature maps output by the second block 204B are provided via a second connecting path 231B to the fourth block 204D and concatenated with the feature maps that are received by the fourth block 204D from the third block 204C.

Each block of the multiple blocks 204 of the generative model 130 includes one or more spatial modules and one or more temporal modules. In some examples, the one or more spatial modules may include a residual block (resblock) module 220 (also referred to as a resblock layer), a transformer module 224 (also referred to as a transformer layer), or a combination thereof. Additionally, or alternatively, the one or more temporal modules may include a temporal resblock module 222 (also referred to as a temporal resblock layer), a temporal transformer module 226 (also referred to as a temporal transformer layer), or a combination thereof. Each block of the multiple blocks 204 of the generative model 130 may have the same number of spatial modules, the same number of temporal modules, or a combination thereof. In other examples, a first block of the multiple blocks 204 of the generative model 130 includes a different number of spatial modules, a different number of temporal modules, or both, as compared to a second block of the multiple blocks 204 of the generative model 130.

In the example of the generative model 130 depicted in FIG. 2, the first block 204A includes a resblock module 220A, a temporal resblock module 222A, a transformer module 224A, and a temporal transformer module 226A. The second block 204B of the generative model 130 includes a resblock module 220B, a temporal resblock module 222B, a transformer module 224B, and a temporal transformer module 226B. The third block 204C of the generative model 130 includes a resblock module 220C, a temporal resblock module 222C, a transformer module 224C, and a temporal transformer module 226C. The fourth block 204D of the generative model 130 includes a resblock module 220D, a temporal resblock module 222D, a transformer module 224D, and a temporal transformer module 226D. The fifth block 204E of the generative model 130 includes a resblock module 220E, a temporal resblock module 222E, a transformer module 224E, and a temporal transformer module 226E.

In some embodiments, the resblock module 220, the temporal resblock module 222, or a combination thereof, is configured to perform an upsampling operation (that increases a resolution), a downsampling operation (that lowers a resolution), another operation, or a combination thereof. Additionally, or alternatively, the transformer module 224, the temporal transformer module 226, or a combination thereof, is configured to generate activations. For example, a transformer, such as the transformer module 224 or the temporal transformer module 226, includes an activation function that operates on an input of the transformer to generate activation feature data (or an activation map) that is referred to as activations. Each of the activations (e.g., an activation map) is a rich representation that may indicate or represent image structure information, such as motion associated with an input of the transformer. Within the generative model 130, activations associated with a low-resolution block (e.g., the third block 204C) can indicate or represent coarse motion data that is associated with object-level motions (e.g., semantics correspondences), and activations associated with a high-resolution block (e.g., the first block 204A or the fifth block 204E) can indicate or represent fine motion data that is associated with pixel level-type motions (e.g., pixel-level correspondences).

In some embodiments, the generative model 130 includes a first set of one or more layers 240 and a second set of one or more layers 250. The first set of one or more layers 240 may be associated with a first resolution and the second set of one or more layers 250 may be associated with a second resolution that is less than the first resolution. In the embodiment of the generative model 130 of FIG. 2, the first set of one or more layers 240 includes the first layer (that includes the first block 204A and the fifth block 204E), and the second set of one or more layers 250 includes the second layer (that includes the second block 204B and the fourth block 204D) and the third layer (that includes the third block 204C).

The modified generative model 150 includes the first set of one or more layers 240 and the adapter 138. The adapter 138 is configured to approximate operation of the second set of one or more layers 250 of the multiple layers 132 of the generative model 130. The adapter 138 is configured to receive feature maps (having a first resolution) from the first block 204A via the first downsample path 232A. Additionally, the adapter 138 is configured to receive at least a portion of an input to the modified generative model 150, where the input includes one or more feature maps (having the first resolution) and one or more feature maps (having the second resolution). For example, the adapter 138 may receive the one or more feature maps (having the second resolution) via a path 260. In some embodiments, the one or more feature maps (having the second resolution) are received from the second set of one or more layers 250 of the generative model 130. To illustrate, the generative model 130 may be applied by the denoiser 122 at sampling step that is prior to a sampling step in which the denoiser applies the modified generative model 150, and the adapter 138 of the modified generative model 150 may receive the one or more feature maps (having the second resolution) via path 260 from the generative model 130 applied during the prior sampling step. The adapter 138 is configured to provide an output of one or more feature maps to the fifth block 204E via the path 234B. In some embodiments, the adapter 138 is configured to approximate and output one or more features and/or one or more activations associated with the blocks of the second set of one or more layers 250 of the generative model 130—e.g., the second block 204B, the third block 204C, the fourth block 204D, or a combination thereof. An example of the adapter 138 is described further herein at least with reference to FIG. 3.

Referring to FIG. 3, FIG. 3 is a block diagram to illustrate an example 300 of the adapter 138 of the system 100 of FIG. 1, in accordance with one or more aspects of the present disclosure. With respect to one or more inputs and/or one or more outputs of the adapter 138, the adapter 138 is described with reference to operation of the adapter 138 at a current sampling step of multiple sampling operations performed by the denoiser 122. It is noted that the adapter 138 (and components thereof) shown and described with reference to FIG. 3 is provided for illustrative purposes and that other configurations of the adapter 138 (and/or components thereof) are possible. Accordingly, the adapter 138 (and components thereof) should not be limited to the illustrative example of the adapter 138 of FIG. 3.

The adapter 138 includes a first convolutional module 302 (e.g., a first 3D convolutional module), a linear function module 304, a combiner 306 (e.g., a concatenator), one or more spatial-temporal modules 310 (referred to herein as the “the spatial-temporal module 310”), and a second convolution module 312 (e.g., a second 3D convolutional module). The first convolutional module 302 (e.g., a first 3D convolutional module) is configured to receive a low resolution input 350 and a high resolution input 352. The high resolution input 352 is associated with a first resolution and corresponds to a feature output of a first layer (e.g., the first layer 134) of the current sampling step. The low resolution input 350 is associated with a second resolution (that is a lower resolution than the first resolution). The low resolution input 350 corresponds to a feature output of a second layer (e.g., the second layer 136) of a previous sampling step that occurred prior to the current sampling step. In some embodiments, the first convolution module 302 may receive the low resolution input 350 output from one or more previous sampling steps.

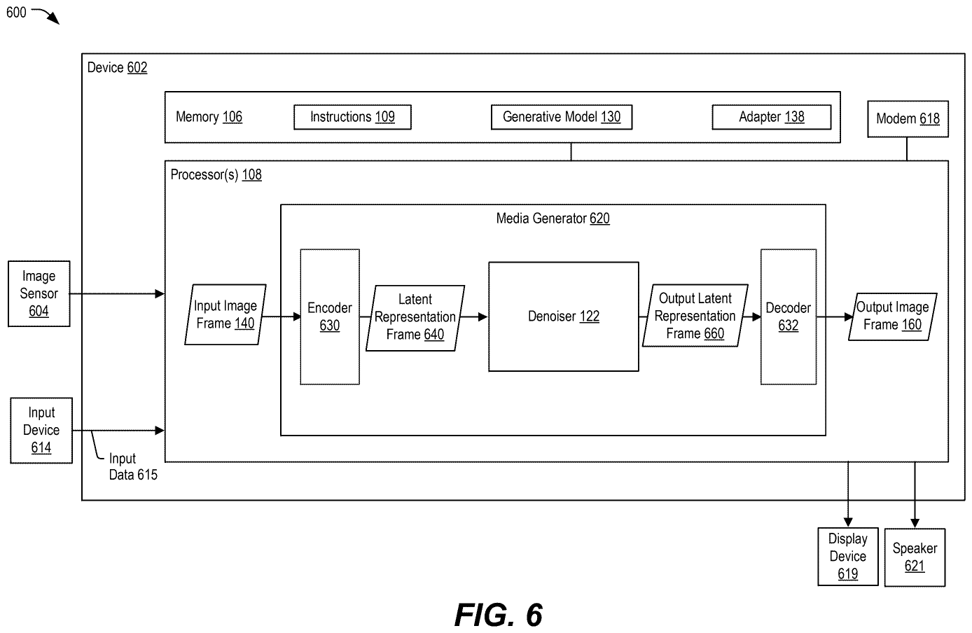

The linear function module 304 is configured to receive an image-embedding 354 (e.g., image-embedding data) and perform a linear function based on the image-embedding 354. The image-embedding 354 (e.g., image-embedding data) may be output by an encoder, such as an encoder 630, as described herein with reference to FIG. 6, based on the input image frame 140. The combiner 306 (e.g., a concatenator) is configured to receive an output of the first convolutional module 302 and an output of the linear function module 304. The combiner 306 is configured to combine (e.g., concatenate) the output of the first convolutional module 302 and the output of the linear function module 304 that is output by the combiner 306.

The spatial-temporal module 310 includes a representative first spatial-temporal module 310A and a second spatial-temporal module 310B. Although the adapter 138 is described as including two spatial-temporal modules 310, in other embodiments, the spatial-temporal module 310 may include a single spatial-temporal module or two or more spatial-temporal modules. In embodiments in which the spatial-temporal module includes multiple spatial-temporal modules, the multiple spatial-temporal modules may be coupled (e.g., arranged) in series, and an initial spatial-temporal module, such as the first spatial-temporal module 310A, is configured to receive an output (e.g., a concatenation of the output of the first convolutional module 302 and the output of the linear function module 304) of the combiner 306.

Each spatial-temporal module 310 is also configured to receive a time-embedding 356, an image-only indicator 358, and an alpha value 359 (of a parameter alpha α). The time-embedding 356 (e.g., time-embedding data) may indicate or be associated with a current sampling step. In some implementations, the time-embedding 356 may include the current sampling step with reference to an initial sampling step or a total number of remaining sampling steps to be performed. The image-only indicator 358 (e.g., an image indicator) may indicate which frame of multiple frames is or corresponds to an input image frame, such as the input image frame 140.

An example of the spatial-temporal module 310 is shown and designated 370. In the example 370, the spatial-temporal module 310 is configured to receive an input 380 and generate an output 390. The spatial-temporal module 310 includes a spatial residual network (resnet) 372 (e.g., a 2D resnet), a temporal resnet 374, and an alpha blender 376.

The spatial resnet 372 is configured to receive the input 380 and the time-embedding 356, and output spatial information Zₛ. The spatial information Zₛ may be provided as an input to the temporal resnet 374 and the alpha blender 376. In some embodiments, the spatial information Zₛ is reshaped (e.g., by a reshaper unit) and the reshaped spatial information Zₛ is provided as an input to the temporal resnet 374 and the alpha blender.

In some embodiments, the spatial resnet 372 includes one or more spatial convolutional layers that are configured to interpret a video as a batch of independence images. Additionally, or alternatively, the spatial resnet 372 may include a group norm (GroupNorm) function unit, a sigmoid linear unit (SiLU), a 2D convolution unit, a combiner (e.g., a concatenator), a dropout function unit, or a combination thereof. In a particular embodiment, the spatial resnet 372 includes (in a sequential processing order) a GroupNorm function unit, a first SiLU, a first 2D convolution unit, a combiner configured to concatenate an output of the first 2D convolution unit and a linearization of the time-embedding 356, a second SiLU, a dropout function unit, and a second 2D convolution unit. In some such examples, the time-embedding 356 is provided to a linear function unit and the output of the linear function unit is provided to the combiner of the spatial resnet 372.

The temporal resnet 374 is configured to receive the spatial information Zₛ (or a reshaped version of the spatial information Zₛ) and the time-embedding 356, and output temporal information Zₜ. The temporal information Zₜ may be provided as an input to the alpha blender 376.

In some embodiments, the temporal resnet 374 includes one or more temporal convolutional layers that are configured to process a video along a video-time dimension. Additionally, or alternatively, the temporal resnet 374 may include a GroupNorm function unit, a non-linearity function unit, a 2D convolution unit, a combiner (e.g., concatenator), a dropout function unit, or a combination thereof. In a particular embodiment, the temporal resnet 374 includes (in a sequential processing order) a first GroupNorm function unit, a non-linearity function unit, a first 2D convolution unit, a combiner configured to concatenate an output of the first 2D convolution unit and a linearization of the time-embedding 356, a second GroupNorm function unit, a second non-linearity function unit, a dropout function unit, and a second 2D convolution unit. In some such examples, the time-embedding 356 is provided to a non-linearity function unit and the output of the non-linearity unit is provided to a linear function unit that provides an output to the combiner of the temporal resnet 374.

The alpha blender 376 is configured to receive the spatial information Zₛ (output by the spatial resnet 372), the temporal information Zₜ (output by the temporal resnet 374), the alpha value 359, the image-only indicator 358, or a combination thereof. In some embodiments, the alpha blender 376 is configured to combine the spatial information Zₛ (output by the spatial resnet 372) and the temporal information Zₜ (output by the temporal resnet 374). In some examples, the alpha blender 376 is configured to combine the spatial information Zₛ and the temporal information Zₜ based on the alpha value 359 (e.g., the parameter alpha α), such that the output 390 is equal to: α*zₛ+(1−α) zₜ. [[INVENTOR—HOW DOES THE IMAGE-ONLY INDICATOR GET USED IN RELATION TO THE EQUATION AND/OR THE ALPHA BLENDER 376?]]

Referring back to the adapter 138 of the example 300, an output of the spatial-temporal module 310, such as a final spatial-temporal module (e.g., the second spatial-temporal module 310B) is configured to provide an output to the second convolution module 312. The second convolution module 312 (e.g., a second 3D convolutional module) is configured to generate a low resolution output 360. The low resolution output 360 is associated with the second resolution (that is a lower resolution than the first resolution). The low resolution output 360 may be or include a feature output that may be associated with an approximation of an output of the second layer (e.g., the second layer 136) for the current sampling step.

Referring back to FIG. 1, the processor 108 includes a media generator 120. The media generator 120 includes a denoiser 122. Each of the media generator 120, the denoiser 122, or portions thereof, may be implemented by the processor 108 executing instructions (e.g., software), dedicated hardware (e.g., circuitry), or a combination thereof.

In some embodiments, the media generator 120 (e.g., the denoiser 122) is configured to receive input media data (e.g., the input image frame 140) and generate output media data (e.g., the output image frame 160). To illustrate, the media generator 120 (e.g., the denoiser 122) may include the generative model 130, the modified generative model 150, another model, the adapter 138, or a combination thereof. For example, the media generator 120 (e.g., the denoiser 122) may be configured to obtain the generative model 130, the modified generative model 150, another model, the adapter 138, or a combination thereof, from the memory 106. In some embodiments, the media generator 120 (e.g., the denoiser 122) is configured to obtain the generative model 130 and the adapter 138, and generate the modified generative model 150 based on the generative model 130 and the adapter 138. In some such embodiments, the media generator 120 stores the modified generative model 150 at the memory 106.

The media generator 120 is configured to perform one or more media generation operations to generate media data, such as image data, audio data, video data, game data, graphics data, or a combination thereof, as illustrative, non-limiting examples. In some embodiments, the one or more media generation operations include one or more video generation operations associated with generation of video content. For example, the one or more video generation operations may include or correspond to a denoising operation, image-based video generation, text-based video content generation, text-based video content editing, video enhancement (e.g., super-resolution, colorization, etc.), video compression, or data augmentation for model training and evaluation.

The denoiser 122 is configured to perform multiple sampling operations (e.g., sampling steps), such as a series of sampling steps. In some embodiments, the multiple sampling operations includes a number of sampling operations, such as twelve, twenty-five, or more than twenty-five sampling operations, as illustrative, non-limiting examples. The multiple sampling operations can be performed on a series of image frames that are each based on the input image frame 140. Each sampling operation of the multiple sampling operations may use a model, such as the generative model 130 or the modified generative model 150. In some embodiments, the multiple sampling operations include multiple denoising operations, such as multiple diffusion denoising functions, on noise data (e.g., a noise vector) and generate denoised data.

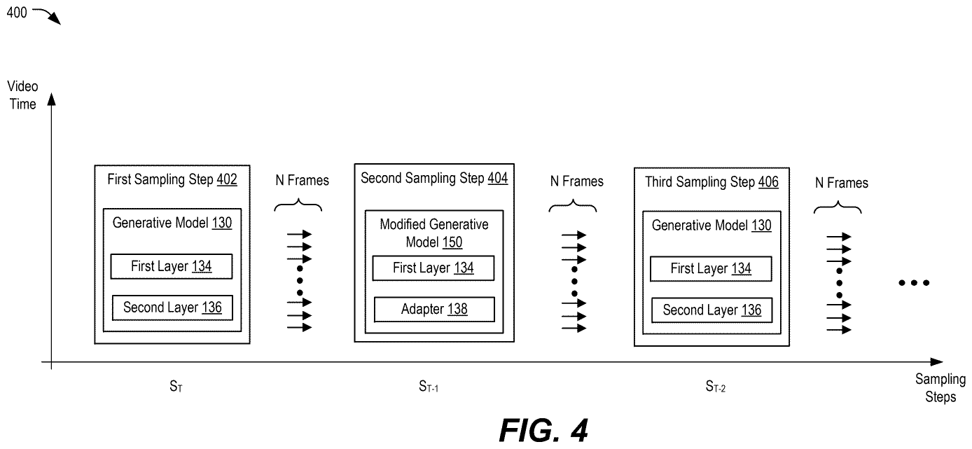

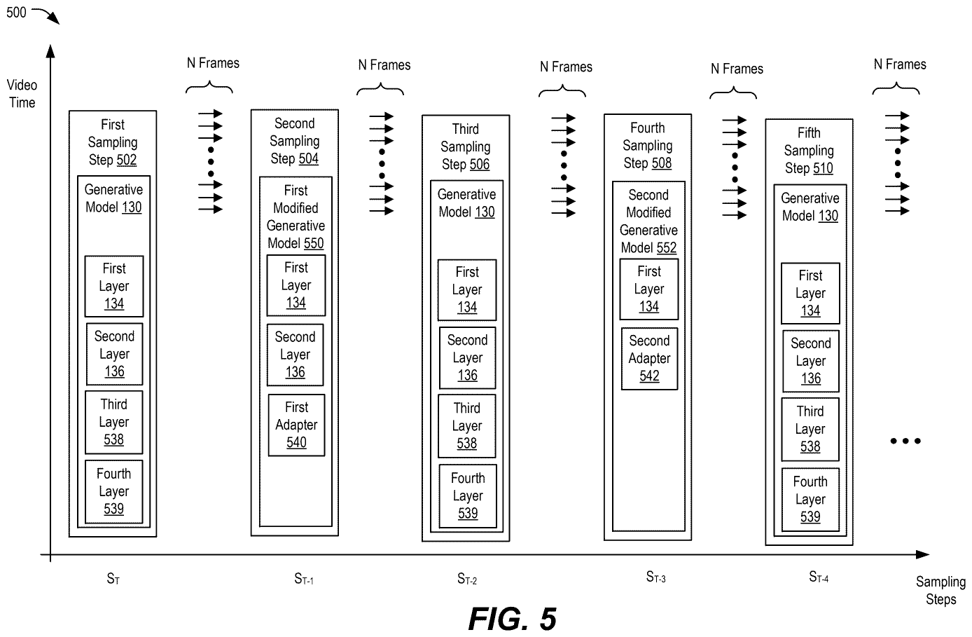

In some embodiments, the denoiser 122 is configured to perform the multiple sampling operations based on or according to a scheme or pattern. The sequence or pattern may indicate, for each sampling operation of the multiple sampling operations, which model (e.g., the generative model 130 or the modified generative model 150) that the denoiser 122 is to use during the sampling operation. For example, use of the modified generative model 150 may be interleaved within use of the generative model 130. In some embodiments, the modified generative model 150 may not be used for two consecutive sampling operations of the multiple sampling operations, may not be used for an initial sampling operation of the multiple sampling operations, or a combination thereof. Additionally, or alternatively, two or more consecutive sampling operations that use the generative model 130 may be performed between two sampling operations that each use the modified generative model 150. Examples of different schemes or patterns are described further herein at least with reference to FIGS. 4 and 5.

In some embodiments, the media generator 120 includes an encoder, a decoder, or both, as described further herein at least with reference to FIG. 6. The encoder, such as an autoencoder, is configured to receive the input image frame 140 and generate a latent representation frame based on the input image frame 140. The latent representation frame may be provided to the denoiser 122 to perform the multiple sampling operations. An output of the denoiser 122, such as an output latent representation frame may be provided to the decoder, which is configured to generate the output image frame 160 based on the output latent representation frame.

During operation, the processor 108 (e.g., the media generator 120) obtains the input image frame 140. The processor 108 (e.g., the denoiser 122) performs multiple sampling operations (e.g., multiple sampling steps) based on the input image frame 140. The processor 108 (e.g., the media generator 120) outputs the output image frame 160 based on the multiple sampling operations performed by the denoiser 122. In some embodiments, the processor 108 (e.g., the media generator 120) outputs, as the output image frame 160, fourteen or more image frames (associated with the input image frame 140).

In some embodiments, to perform the multiple sampling operations, the media generator 120 (e.g., the denoiser 122) obtains the generative model 130, the adapter 138, the modified generative model 150, or a combination thereof. The media generator 120 (e.g., the denoiser 122) performs a first sampling operation (of the multiple sampling operations) based on the modified generative model 150. To perform the first sampling operation, the denoiser 122 performs a first portion of the first sampling operation via the first set of one or more layers (e.g., the first layer 134). Additionally, to perform the first sampling operation, the denoiser 122 also performs a second portion of the first sampling operation via the adapter 138 (associated with or having the second resolution).

The media generator 120 (e.g., the denoiser 122) also performs a second sampling operation (of the multiple sampling operations) based on the generative model 130. For example, the denoiser 122 performs the second sampling operations via the multiple layers 132 of the generative model 130. The second sampling operation can be performed prior or subsequent to the first sampling operation. Additionally, or alternatively, a first power consumption of performance of the first sampling stage is less than a second power consumption of performance of the second sampling stage. To illustrate, the first stage may use approximately twenty-six tera floating point operations (TFLOPs), and the second sampling stage may use approximately seventy-two TFLOPs.

In some embodiments, the media generator 120 (e.g., the denoiser 122) performs a third sampling operation (of the multiple sampling operations based on the modified generative model 150. To perform the third sampling operation, the denoiser 122 performs a first portion of the third sampling operation via the first set of one or more layers (e.g., the first layer 134). Additionally, to perform the third sampling operation, the denoiser 122 also performs a second portion of the third sampling operation via the adapter 138. In some examples, the second sampling operation is performed after the first sampling operation, and the third sampling operation is performed after the second sampling operation.

In some embodiments, a device (e.g., the device 102) includes a memory (e.g., the memory 106) and one or more processors (e.g., the processor 108) coupled to the memory. The memory is configured to store an adapter (e.g., the adapter 138) and a generative model (e.g., the generative model 130) including multiple layers (e.g., the multiple layers 132). The processor is configured to obtain an input image frame (e.g., the input image frame 140). The processor is also configured to, based on the input image frame and for a first sampling operation of multiple sampling operations, perform a first portion of the first sampling operation via a first set of one or more layers of the multiple layers of the generative model. The first set of one or more layers includes a first layer (e.g., the first layer 134) associated with a first resolution. The processor is further configured to, based on the input image frame and for the first sampling operation, perform a second portion of the first sampling operation via the adapter, the adapter associated with a second resolution that is different from the first resolution. The one or more processors are configured to output, based on the multiple sampling operations, one or more output image frames (e.g., the output image frame 160).

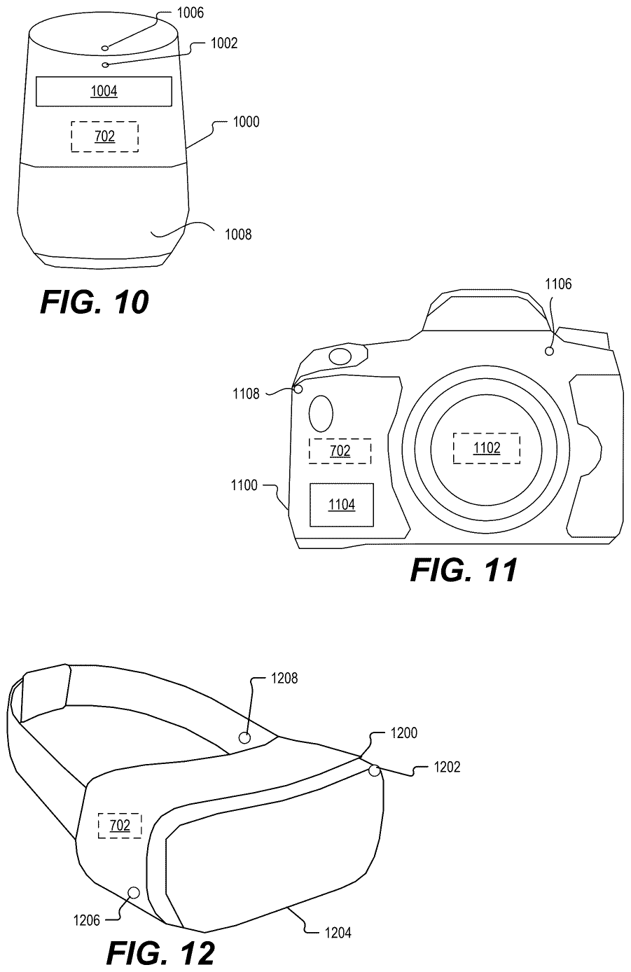

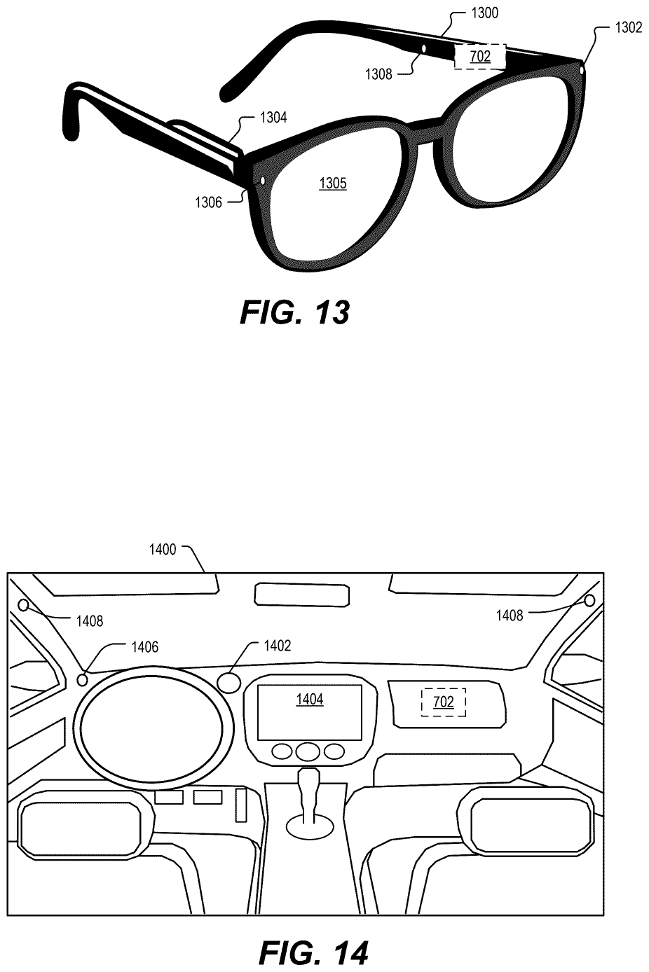

In some examples, the device 102 corresponds to or is included in one of various types of devices, such that the processor 108 can be integrated in multiple types of devices. In an illustrative example, the processor 108 is integrated in a wearable electronic device as depicted in FIG. 9, a virtual reality, mixed reality, or augmented reality headset as depicted in FIG. 12, a mixed reality or augmented reality glasses device as described with reference to FIG. 13, or another wearable device. In another illustrative example, the processor 108 is integrated in a mobile device (a mobile phone or a tablet) as depicted in FIG. 8, a voice-controlled speaker system as depicted in FIG. 10, a camera as depicted in FIG. 11, a vehicle as depicted in FIG. 14, a computer or a server, or another system or device.

One technical advantage of implementing the device 102 as described above is that a sampling operation performed using the modified generative model 150 can be performed faster and conserver power as compared to a sampling operation performed using the generative model 130. Additionally, the techniques described herein can perform the multiple sampling operations using the generative model 130 and the modified generative model 150 (including the adapter 138) to generate video data that would otherwise take longer and be more computationally expensive as compared to conventional techniques which use the same generative model for each sampling operation of the multiple sampling operations. For example, as compared to the conventional techniques, the techniques described herein can reduce a cost (e.g., an amount of time and/or power consumption) of video generation by approximately thirty percent with little to no loss in temporal consistency and video quality.

FIGS. 4 and 5 are diagrams to illustrate examples of multiple sampling steps associated with generation of media data, in accordance with some examples of the present disclosure. For example, FIG. 4 illustrates a first example 400 of multiple sampling steps associated with generation of media data (e.g., the output image frame 160) and FIG. 5 illustrates a first example 500 of multiple sampling steps associated with generation of media data (e.g., the output image frame 160). Each of the examples 400 and 500 depicts multiple sampling steps along an x-axis and video time along a y-axis. The multiple sampling steps may be performed by the processor 108 (e.g., the media generator 120) of FIG. 1. The multiple sampling steps (e.g., sampling operations) may include a total of T steps, where T is a positive integer greater than or equal to two. As an example, the multiple sampling steps may be performed by the denoiser 122 on multiple image frames, such as N frames, where N is a positive integer greater than or equal to two. In some embodiments, N is equal to fourteen or twenty-five. The multiple image frames may be based on or associated with an input image frame, such as the input image frame 140.

Referring to FIG. 4, the multiple sampling steps include a first sampling step (S_{T}) 402, a second sampling step (S_{T-1}) 404, and a third sampling step (S_{T-2}) 406. During the first sampling step (S_{T}) 402 and the third sampling step (S_{T-2}) 406, the denoiser 122 uses the generative model 130 (e.g., a first generative model) that includes the multiple layers 132, such as the first layer 134 and the second layer 136. In some embodiments, the multiple layers 132 of the generative model 130 include a first set of one or more layers and a second set of one or more layers. The first set of one or more layers may include the first layer 134, and the second set of one or more layers may include the second layer 136. The first set of one or more layers and/or the first layer 134 may be associated with a first resolution, and the second set of one or more layers and/or the second layer 136 may be associated with a second resolution. In some embodiments, the second resolution is a lower resolution than the first resolution. In other embodiments, the second resolution is a higher resolution than the first resolution.

During the second sampling step (S_{T-1}) 404, the denoiser 122 uses the modified generative model 150 (e.g., a second generative model) that includes the first layer 134 and the adapter 138. In some embodiments, modified generative model includes the first set of one or more layers that includes the first layer 134. The adapter 138 may be associated with the second resolution.

The generative model 130 applied at the first sampling step (S_{T}) 402 may output the N frames (e.g., feature data of the N frames) that are provided as an input to the modified generative model 150 of the second sampling step (S_{T-1}) 404. The modified generative model 150 applied at the second sampling step (S_{T-1}) 404 may output the N frames (e.g., feature data of the N frames) that are provided as an input to the generative model 130 of the third sampling step (S_{T-2}) 406. The generative model 130 applied at the third sampling step (S_{T-2}) 406 may output the N frames (e.g., feature data of the N frames) that are provided as an input to a next sampling step or as an output (e.g., the output image frame 160) of the denoiser 122. It is noted that the scheme or pattern of the generative model 130 and the modified generative model 150 that is applied during the sampling steps of the embodiment of FIG. 4 is provided for illustrative purposes and that a different scheme or pattern may be performed. For example, the second sampling step (S_{T-1}) may apply the generative model 130 and the third sampling step (S_{T-2}) 406 may apply the modified generative model 150.

Referring to FIG. 5, the multiple sampling steps include a first sampling step (S_{T}) 502, a second sampling step (S_{T-1}) 504, a third sampling step (S_{T-2}) 506, a fourth sampling step (S_{T-3}) 508, and a fifth sampling step (S_{T-4}) 510. During the first sampling step (S_{T}) 502, the third sampling step (S_{T-2}) 506, and the fifth sampling step (S_{T-4}) 510, the denoiser 122 uses the generative model 130 (e.g., a first generative model) that includes the multiple layers 132, such as the first layer 134, the second layer 136, a third layer 538, and a fourth layer 539.

During the second sampling step (S_{T-1}) 504, the denoiser 122 uses a first modified generative model 550 (e.g., a second generative model) that includes the first layer 134, the second layer 136, and a first adapter 540. The first adapter 540 may include or correspond to the adapter 138. The first modified generative model 550 may include a respective first set of one or more layers, such as the first layer 134 and the second layer 136, of the multiple layers of the generative model 130 and the first adapter 540. The first set of one or more layers (of the first modified generative model 550) may be associated with a first resolution and the adapter 540 may be associated with a second resolution that is a lower resolution than the first resolution.

During the fourth sampling step (S_{T-3}) 508, the denoiser 122 uses a second modified generative model 552 (e.g., a third generative model) that includes the first layer 134 and a second adapter 542. The second adapter 542 may include or correspond to the adapter 138. The second modified generative model 552 may include a respective first set of one or more layers, such as the first layer 134, of the multiple layers of the generative model 130 and the second adapter 542. The first set of one or more layers (of the second modified generative model 552) may be associated with the first resolution and the adapter 540 may be associated with a third resolution and/or a second resolution. The third resolution may be a lower resolution than the first resolution. Additionally, or alternatively, the third resolution may be a higher resolution than the second resolution.

The generative model 130 applied at the first sampling step (S_{T}) 502 may output the N frames (e.g., feature data of the N frames) that are provided as an input to the first modified generative model 550 of the second sampling step (S_{T-1}) 504. The first modified generative model 550 applied at the second sampling step (S_{T-1}) 504 may output the N frames (e.g., feature data of the N frames) that are provided as an input to the generative model 130 of the third sampling step (S_{T-2}) 506. The generative model 130 applied at the third sampling step (S_{T-2}) 506 may output the N frames (e.g., feature data of the N frames) that are provided as an input to the second modified generative model 552 of the fourth sampling step (S_{T-3}) 508. The second modified generative model 552 applied at the fourth sampling step (S_{T-3}) 508 may output the N frames (e.g., feature data of the N frames) that are provided as an input to the generative model 130 of the fifth sampling step (S_{T-4}) 510. The generative model 130 applied at the fifth sampling step (S_{T-4}) 510 may output the N frames (e.g., feature data of the N frames) that are provided as an input to a next sampling step or as an output (e.g., the output image frame 160) of the denoiser 122.

It is noted that the scheme or pattern of the generative model 130, the first modified generative model 550, and the second modified generative model 552 that is applied during the sampling steps of the embodiment of FIG. 5 is provided for illustrative purposes and that a different scheme or pattern may be performed. For example, the second sampling step (S_{T-1}) may apply the generative model 130 or the second modified generative model 552. Additionally, or alternatively, as another example, the third sampling step (S_{T-2}) 506 and/or the fifth sampling step (S_{T-4}) 510 may apply the first modified generative model 550 or the second modified generative model 552. Additionally, or alternatively, as another example, the fourth sampling step (S_{T-3}) 508 may apply the generative model 130 or the first modified generative model 550.

FIG. 6 is a block diagram of a particular illustrative aspect of a system 600 that is operable to generate media data, in accordance with some examples of the present disclosure. The system 600 includes a device 602 that may include or correspond to the device 102 of FIG. 1.

The device 602 includes the memory 106, the processor 108, and a modem 618. The modem 618 is coupled to the processor 108 and is configured to transmit video content (e.g., the output image frames 160) to a second device for output by the second device. Additionally, or alternatively, the modem is configure to receive video content (e.g., the input image frames 140), a model (e.g., the generative model 130 or the modified generative model 150, 550, or 552), the adapter 138, 540, or 542, or a combination thereof, from a second device for processing and playback at the device 602, or both. The memory 106 is configured to store the instructions 109, the generative model, and the adapter 138. The instructions 109, when executed by the processor 108, cause the processor 108 to perform one or more operations as described herein.

The processor 108 is also coupled to an image sensor 604, an input device 614 (e.g., a microphone, a keyboard or touch screen, etc.), a display device 619, and a speaker 621. The image sensor 604 may include one or more cameras and may be configured to generate an image frame, such as the input image frame 140. Media data, such the output image frame 160 (e.g., video content), may be generated by the processor 108 at least partially based on the input image frame 140. The input device 614 is configured to receive an input and provide the input to the processor 108 as input data 615. For example, the input device 614 may include a keyboard, a touch screen, or a microphone configured to receive the input and provide the input data 615 (e.g., an input signal) to the processor 108. The input (e.g., the input data 615) may include or indicate a request to generate media data, such as video content. In some examples, the input includes a request to perform an image-to video generation, text-based video generation, a text-based video content editing operation, a video enhancement operation, video compression, a data augmentation operation, or a combination thereof.

The display device 619 is coupled to the processor 108 and is configured to output the output image frame 160 generated based on the input image frame 140. In some examples, the display device 619 includes a display screen, a monitor or television, a projector, or a combination thereof. In some embodiments, the device 602 may include or be couped to the processor 108 and is configured to output audio associated with video content (e.g., the output image frame 160) generated based on the input image frame 140.

The image sensor 604, the input device 614, the display device 619, the speaker 621, or a combination thereof, may be coupled to or integrated within the device 602. Although the device 602 is described as being coupled to or including the image sensor 604, the input device 614, the modem 618, the display device 619, and the speaker 621, in other embodiments the device 602 may not include or be coupled to the image sensor 604, the input device 614, the modem 618, the display device 619, the speaker 621, or a combination thereof. For example, the image sensor 604, the input device 614, the modem 618, the display device 619, the speaker 621, or a combination thereof, may be included in another device, such as a wearable device, that is configured to be coupled to the device 602.

The processor 108 of FIG. 6 includes the media generator 620. The media generator 620 may include or correspond to the media generator 120. The media generator 620 includes an encoder 630, the denoiser 122, and a decoder 632. In some examples, the encoder 630 is, includes, or is included in a variational autoencoder (VAE). The encoder 630 is configured to receive the input image frame 140 and generate the latent representation frame 640 based on the input image frame 140. For example, the encoder 630 may include a neural network configured to extract latents (e.g., low dimensional representations). In some such examples, the encoder 630 performs one or more operations to compress the input image frame 140 into the latent space. To illustrate, the encoder 630 receives the input image frame 140 and performs the one or more operations to generate the latent representation frame 640.

The denoiser 122 receives the latent representation frames 640 and performs multiple sampling operations, as described at least with reference to FIGS. 1 4, or 5. The denoiser 122 outputs, in the latent space, one or more output latent representation frames 660 (referred to herein as the “output latent representation frame 660”) based on the latent representation frame 640.

The decoder 632 receives the output latent representation frame 660. Additionally, the decoder decodes the output latent representation frame 660 to generate the output image frame 160.

In some examples, the device 602 corresponds to or is included in one of various types of devices, such that the processor 108 can be integrated in multiple types of devices. In an illustrative example, the processor 108 of the device 602 is integrated in a mobile device (e.g., a mobile phone or tablet) as depicted in FIG. 8, a wearable electronic device as depicted in FIG. 9, a voice-controlled speaker system as depicted in FIG. 10, a camera as depicted in FIG. 11, a virtual reality, mixed reality, or augmented reality headset as depicted in FIG. 12, a mixed reality or augmented reality glasses device, as described with reference to FIG. 13, or a vehicle as depicted in FIG. 14.

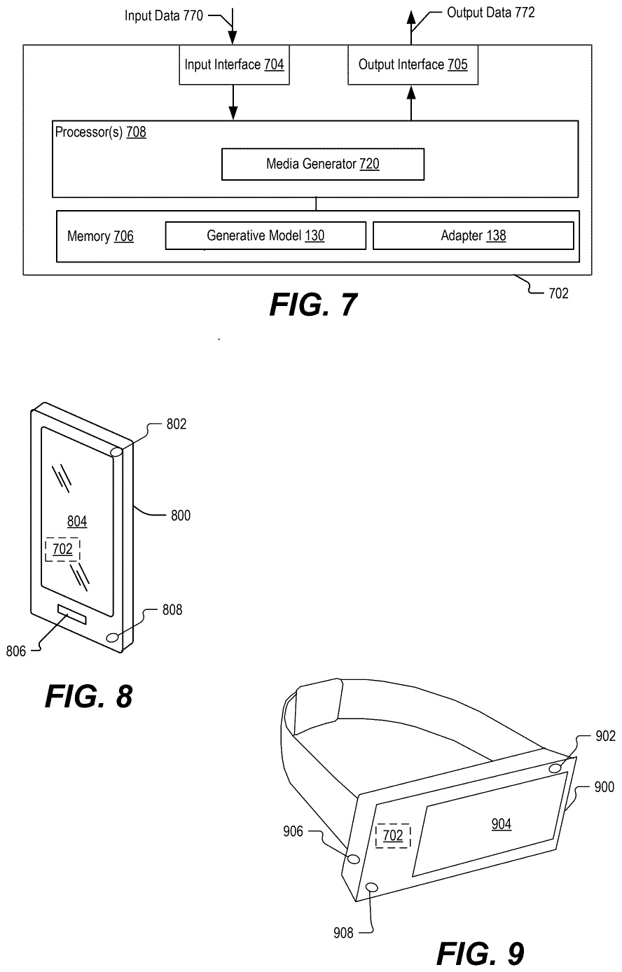

FIG. 7 depicts a diagram of an example of an integrated circuit 702 operable to generate media data, in accordance with some examples of the present disclosure. For example, the media data may include or correspond to the output image frame 160.

The integrated circuit 702 includes one or more processors 708 (herein after referred to as the “processor 708”) and a memory 706. The processor 708 and the memory 706 may include or correspond to the processor 108 and the memory 106, respectively. The processor 708 may include a media generator 720. The media generator 720 may include or correspond to the media generator 120 or 620. The memory 706 includes (e.g., stores) the generative model 130 and the adapter 138. Although the memory 706 includes both the generative model 130 and the adapter 138 in the embodiment shown, in other embodiments the memory may not include the generative model 130, the adapter 138, or a combination thereof. Additionally, or alternatively, the memory 706 may include one or more other models (e.g., the modified generative model 150, the first modified generative model 550, or the second modified generative model 552), one or more other adapters (e.g., the first adapter 540 and/or the second adapter 542), the input image frame 140, the output image frame 160, or a combination thereof. In some embodiments, the integrated circuit 702 may not include the memory 706.

The integrated circuit 702 also includes an input interface 704, such as one or more bus interfaces, to enable the integrated circuit 702 to receive signals representing input data 770 for processing. For example, the input data 770 can correspond to or include the instructions 109, the generative model 130, the adapter 138, the input image frame 140, the modified generative model 150, the first modified generative model 550, the second modified generative model 552, the first adapter 540, the second adapter 542, the input data 615, or a combination thereof.

The integrated circuit 702 also includes an output interface 705, such as a bus interface, to enable the integrated circuit 702 to output signals representing output data 772. For example, the output data 772 can correspond to or include the modified generative model 150, the output image frame 160, the first modified generative model 550, the second modified generative model 552, or a combination thereof.

The integrated circuit 702 including the media generator 720 and, optionally, the generative model 130, a modified generative model (e.g., the modified generative model 150, the first modified generative model 550, or the second modified generative model 552), and/or an adapter (e.g., the adapter 138, the first adapter 540, or the second adapter 542) enables implementation of media data (e.g., the output image frame 160) generation in a system or a device. For example, the system or the device may include a mobile device (e.g., a mobile phone or tablet) as depicted in FIG. 8, a wearable electronic device as depicted in FIG. 9, a voice-controlled speaker system as depicted in FIG. 10, a camera as depicted in FIG. 11, a virtual reality, mixed reality, or augmented reality headset as depicted in FIG. 12, a mixed reality or augmented reality glasses device, as described with reference to FIG. 13, or a vehicle as depicted in FIG. 14.

In some embodiments, the system or the device that includes the integrated circuit 702 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 604, the input device 614, the display device 619, the speaker 621, and the modem 618, respectively.

In some embodiments, the system or the device that includes the integrated circuit 702 is operable to generate media data, such as video data, based on the generative model 130 and/or the adapter 138. For example, the processor 708 (e.g., the media generator 720) is configured to perform multiple sampling operations (e.g., multiple sampling steps) based on an input image frame, such as the input image frame 140. The media generator 720 (including a denoiser) performs a first sampling operation (of the multiple sampling operations) based on the generative model 130 (e.g., the first genitive model). Additionally, the media generator 720 (e.g., the denoiser) also performs a second sampling operation (of the multiple sampling operations) based on the modified generative model 150 (e.g., the second generative model that includes the adapter 138). The processor 708 (e.g., the media generator 720) is configured to output one or more output image frames (e.g., the output image frame 160), such as a series of image frames of video content, based on the multiple sampling operations.

FIG. 8 depicts a diagram of a mobile device 800 operable to generate media data, in accordance with some examples of the present disclosure. The mobile device 800 may include or correspond to a phone or a tablet, as illustrative, non-limiting examples. The mobile device 800 includes a camera 802 (e.g., an image sensor), a display 804 (e.g., a display screen), a microphone 806, a speaker 808, and the integrated circuit 702. Components of the integrated circuit 702, including the media generator 720 and, optionally, the generative model 130, the adapter 138, 540, or 542, the modified generative model 150, 550, or 552, or a combination thereof, are integrated in the mobile device 800 and are illustrated using dashed lines to indicate internal components that are not generally visible to a user of the mobile device 800.

FIG. 9 depicts a diagram of a wearable electronic device 900 operable to generate media data, in accordance with some examples of the present disclosure. The wearable electronic device 900 may include or correspond to a “smart watch,” as an illustrative, non-limiting example. The wearable electronic device 900 includes a camera 902 (e.g., an image sensor), a display 904 (e.g., a display screen), a microphone 906, a speaker 908, and the integrated circuit 702. Components of the integrated circuit 702, including the media generator 720 and, optionally, the generative model 130, the adapter 138, 540, or 542, the modified generative model 150, 550, or 552, or a combination thereof, is integrated in the wearable electronic device 900 and are illustrated using dashed lines to indicate internal components that are not generally visible to a user of the wearable electronic device 900.

FIG. 10 is a diagram of a voice-controlled speaker system 1000 operable to generate media data, in accordance with some examples of the present disclosure. The voice-controlled speaker system 1000 may include or correspond to a wireless speaker and voice activated device, as an illustrative, non-limiting example. The voice-controlled speaker system 1000 can have wireless network connectivity and is configured to execute an assistant operation. The voice-controlled speaker system 1000 includes a camera 1002 (e.g., an image sensor), a display 1004 (e.g., a display screen), a microphone 1006, a speaker 1008, and the integrated circuit 702. Components of the integrated circuit 702, including the media generator 720 and, optionally, the generative model 130, the adapter 138, 540, or 542, the modified generative model 150, 550, or 552, or a combination thereof, are integrated in the voice-controlled speaker system 1000 and are illustrated using dashed lines to indicate internal components that are not generally visible to a user of the voice-controlled speaker system 1000.

FIG. 11 is a diagram of a camera device 1100 operable to generate media data, in accordance with some examples of the present disclosure. The camera device 1100 includes an image sensor 1102, a display 1104 (e.g., a display screen), a microphone 1106, a speaker 1108, and the integrated circuit 702. Components of the integrated circuit 702, including the media generator 720 and, optionally, the generative model 130, the adapter 138, 540, or 542, the modified generative model 150, 550, or 552, or a combination thereof, are integrated in the camera device 1100 and are illustrated using dashed lines to indicate internal components that are not generally visible to a user of the camera device 1100.

FIG. 12 is a diagram of a headset 1200, such as a virtual reality, mixed reality, or augmented reality headset, operable to generate media data, in accordance with some examples of the present disclosure. A visual interface device is positioned in front of the user's eyes to enable display of augmented reality, mixed reality, or virtual reality images or scenes to the user while the headset 1200 is worn. The headset 1200 also includes a camera 1202 (e.g., an image sensor), a display 1204 (e.g., a display screen), a microphone 1206, a speaker 1208, and the integrated circuit 702. Components of the integrated circuit 702, including the media generator 720 and, optionally, the generative model 130, the adapter 138, 540, or 542, the modified generative model 150, 550, or 552, or a combination thereof, are integrated in the headset 1200 and are illustrated using dashed lines to indicate internal components that are not generally visible to a user of the headset 1200.

FIG. 13 is a diagram of a mixed reality or augmented reality glasses device 1300 operable to generate media data, in accordance with some examples of the present disclosure. The glasses 1300 include a holographic projection unit 1304 configured to project visual data onto a surface of a lens 1305 or to reflect the visual data off of a surface of the lens 1305 and onto the wearer's retina. The glasses 1300 also include a camera 1302 (e.g., an image sensor), a microphone 1306, a speaker 1308, and the integrated circuit 702. Components of the integrated circuit 702, including the media generator 720 and, optionally, the generative model 130, the adapter 138, 540, or 542, the modified generative model 150, 550, or 552, or a combination thereof, are integrated in the glasses 1300 and are illustrated using dashed lines to indicate internal components that are not generally visible to a user of the glasses 1300.

FIG. 14 is a diagram of an example of a vehicle 1400 operable to generate media data, in accordance with some examples of the present disclosure. The vehicle 1400 may include or correspond to a land craft (e.g., a car), a watercraft, or an aircraft (e.g., an aerial device). In some embodiments, the vehicle 1400 includes or corresponds to a manned or unmanned device (e.g., a package delivery drone) generate media data. The vehicle 1400 includes a camera 1402 (e.g., an image sensor), a display 1404 (e.g., a display screen), a microphone 1406, one or more speakers 1408, and the integrated circuit 702. Components of the integrated circuit 702, including the media generator 720 and, optionally, the generative model 130, the adapter 138, 540, or 542, the modified generative model 150, 550, or 552, or a combination thereof, are integrated in the vehicle 1400 and are illustrated using dashed lines to indicate internal components that are not generally visible to a user of the vehicle 1400.

In a particular example of one or more of the devices of FIGS. 8-14, the integrated circuit 702 (e.g., the media generator 720) is operable to generate media data (e.g., the output image frame 160) based on a modified generative model (e.g., the modified generative model 150, 550, or 552) including an adapter (e.g., the adapter 138, 540, 542). For example, based on a request to generate media content, the integrated circuit 702 (e.g., the media generator 720) may perform multiple sampling operations in which at least one sampling operation is performed based on the modified generative model (e.g., the modified generative model 150, 550, or 552) which includes the adapter (e.g., the adapter 138, 540, 542). In some embodiments, the generated media output may be stored at a memory of the integrated circuit 702, sent to another device via a modem coupled to the integrated circuit 702, output via a display or speaker of the one or more devices of FIG. 6 or 8-14, or a combination thereof. One technical advantage of the integrated circuit 702 (e.g., the media generator 720) implemented by the one or more devices of FIGS. 8-14 as described above is that a sampling operation performed using the modified generative model 150 can be performed faster and conserver power as compared to a sampling operation performed using the generative model 130. Additionally, the techniques described herein can perform the multiple sampling operations using the generative model 130 and the modified generative model 150 (including the adapter 138) to generate video data that would otherwise take longer and be more computationally expensive as compared to conventional techniques which use the same generative model for each sampling operation of the multiple sampling operations. For example, as compared to the conventional techniques, the techniques described herein can reduce a cost (e.g., an amount of time and/or power consumption) of video generation by approximately thirty percent with little to no loss in temporal consistency and video quality.

The embodiments of the systems or devices as described with reference to FIGS. 8-14 are described, respectively, as including a display, a microphone, a speaker, a camera, or a combination thereof. As described with reference to FIGS. 8-14, the display, the microphone, the speaker, the camera may include or correspond to the display device 619, the input device 614, the speaker 621, and the image sensor 604, respectively. It is note that in other embodiments of the systems or devices of FIGS. 8-14, one or more of the systems or devices of FIGS. 8-14 may not include the display, the microphone, the speaker, the camera, or a combination thereof. Additionally, or alternatively, one or more of the systems or devices of FIGS. 8-14 may include an additional component. For example, the additional component may include a modem, such as the modem 618.

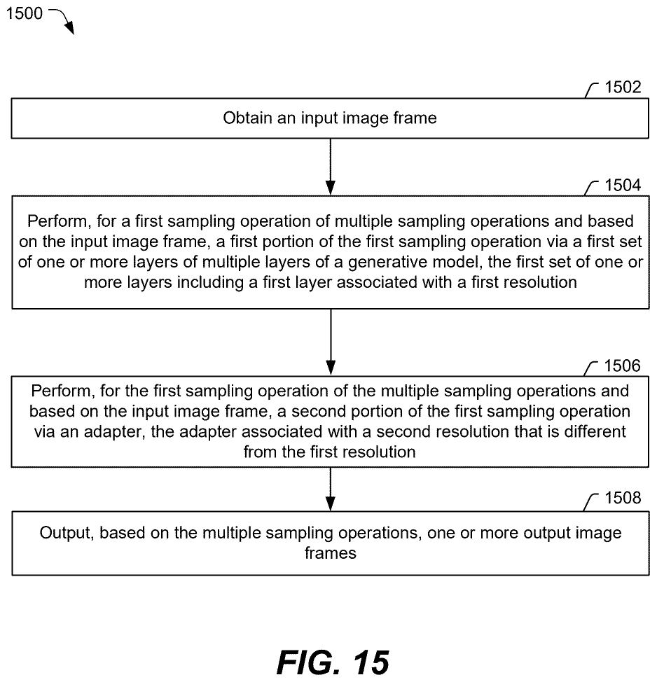

FIG. 15 is a diagram of an example of a method 1500 of generating media data, in accordance with some aspects of the present disclosure. For example, the media data may include or correspond to the output image frame 160. In a particular aspect, one or more operations of the method 1500 are performed by the system 100, the device 102, the processor 108, the media generator 120, the denoiser 122, the system 600, the device 602, the media generator 620, the integrated circuit 702, the processor 708, the media generator 720, one or more of the devices of FIGS. 8-14, or a combination thereof.

In some embodiments, the method 1500 includes, at block 1502, obtaining an input image frame. For example, the input image frame may include or correspond to the input image frame 140 or the latent representation frame 640.

At block 1504, the method 1500 includes performing, for a first sampling operation of multiple sampling operations and based on the input image frame, a first portion of the first sampling operation via a first set of one or more layers of multiple layers of a generative model. The generative model may include or correspond to the generative model 130. The multiple layers of the generative model may include or correspond to the multiple layers 132 that include a first layer associated with a first resolution and a second layer associated with a second resolution (that is different from the first resolution). For example, the first layer and the second layer may include or correspond to the first layer 134 and the second layer 136, respectively. The first set of one or more layers may include the first layer associated with the first resolution. In some embodiment, the multiple sampling operations may be performed by the denoiser 122, such as described at least with reference to FIGS. 1, 4, or 5.

At block 1506, the method 1500 includes performing, for the first sampling operation of the multiple sampling operations and based on the input image frame, a second portion of the first sampling operation via an adapter. For example, the adapter may include or correspond to the adapter 138, 540, or 542. The adapter may be associated with that second resolution that is different from the first resolution. For example, the second resolution may be a lower resolution than the first resolution.

At block 1508, the method 1500 includes outputting, based on the multiple sampling operations, one or more output image frames. For example, the one or more output image frames may include or correspond to the output image frame 160 or the output latent representation frame 660. In some embodiments, the one or more output image frames include fourteen or more image frames associated with the input image frame.

In some embodiments, the method 1500 includes performing the multiple sampling operations. The multiple sampling operations may include two or more sampling operations. For example, the multiple sampling operations (e.g., multiple sampling steps) may include the first sampling operation and a second sampling operation, and optionally a third sampling operation. Each sampling operation of the multiple sampling operations may be performed based on the input image frame. In some embodiments, the method 1500 includes performing the second sampling operations via the multiple layers of the generative model. The second sampling operation can be performed prior to or after the first sampling operation. Additionally, or alternatively, a first power consumption of performance of the first sampling stage may be less than a second power consumption of performance of the second sampling stage.

In some embodiments, the method 1500 includes performing a third sampling operation of the multiple sampling operations. Performing the third sampling operation may include performing a first portion of the third sampling operation via the first set of one or more layers of the multiple layers of the generative model, and performing a second portion of the third sampling operation via the adapter. The third sampling operation may be performed prior to or after the second sampling operation.

In some embodiments, the method 1500 includes performing at least one sampling operation (of the multiple sampling operation) that includes performing a first portion of the at least one sampling operation via a third set of one or more layers of the multiple layers of the generative model, and performing a fourth portion of the at least one sampling operation via another adapter. The third set of one or more layers may include the first layer 134 and may be associated with the first resolution. The second set of layers may be associated with a third resolution that is a lower resolution than the first resolution. Additionally, or alternatively, the at least one sampling resolution may be performed prior to or after the first sampling operation. In some aspects, the at least one sampling operation is performed after the second sampling operation.

In some embodiments, the method 1500 includes encoding, via a VAE, the input image frame to generate a latent representation of the input image frame. For example, the encoder 630 and the latent representation may include or correspond to the encoder and the latent representation frame 640, respectively. Additionally, or alternatively, the method 1500 includes transmitting, via a modem, the one or more output image frames to a second device for output by the second device. For example, the modem may include or correspond to the modem 618. In some embodiments, the method 1500 includes providing, via a microphone, an input signal to the one or more processors to cause the one or more processors to generate the one or more output image frames. For example, the microphone may include or correspond to the input device 614 or a microphone of one or more of the devices of FIGS. 8-14. Additionally, or alternatively, the method 1500 includes outputting, via a speaker, audio associated with the one or more output image frames. The speaker may include or correspond to the speaker 621 or a speaker of one or more of the devices of FIGS. 8-14.

In some embodiments, the method 1500 includes generating, via one or more cameras, image data associated with the input image frame. For example, the one or more cameras may include or correspond to the image sensor 604 or a camera of one or more of the devices of FIGS. 8-14. In some such embodiments, the one or more output image frames may be generated at least partially based on the image data from the one or more cameras. Additionally, or alternatively, the method 1500 may include receiving an input. For example, the input may include or correspond to the input data 615 or 770. The method 1500 may also include outputting, to a display device, the one or more output image frames as video content. For example, the display device may include or correspond to the display device 619 or a display of one or more of the devices of FIGS. 8-14.

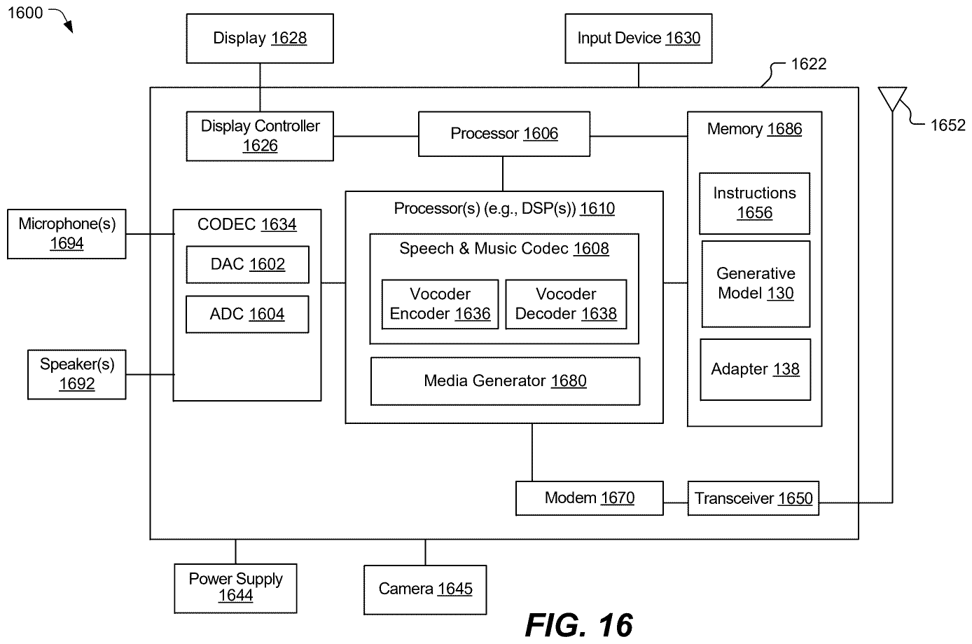

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by a processor that executes instructions, such as described with reference to FIG. 16.

It is noted that one or more blocks (or operations) described with reference to FIG. 15 may be combined with one or more blocks (or operations) described with reference to another of the figures. For example, one or more blocks (or operations) of FIG. 15 may be combined with one or more blocks (or operations) associated with FIGS. 1-14. Additionally, or alternatively, one or more operations described above with reference to FIGS. 1-15 may be combined with one or more operations described with reference to FIG. 16.

FIG. 16 is a block diagram of an illustrative example of a device 1600 that is operable to generate media data, in accordance with one or more aspects of the present disclosure. In various implementations, the device 1600 may have more or fewer components than illustrated in FIG. 16. In an illustrative implementation, the device 1600 may correspond to the device 102 or 602, or to any of the devices of FIGS. 8-14. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor 108 or 708 corresponds to the processor 1606, the processors 1610, or a combination thereof. The processors 1610 may include a speech and music coder-decoder (CODEC) 1608 that includes a voice coder (“vocoder”) encoder 1636, a vocoder decoder 1638, or a combination thereof. Additionally, or alternatively, the processors 1610 may include a media generator 1680. The media generator 1680 may include or correspond to the media generator 120, 620, or 720. In some examples, the processor 1606 or 1610 is configured to generate the modified generative model 150, 550, or 552. To illustrate, the processor 1606 or 1610 is configured to modify the generative model 130 based on the adapter 138 to generate the modified generative model 150, to modify the generative model 130 based on the first adapter 540 to generate the modified generative model 550, or to modify the generative model 130 based on the second adapter 542 to generate the modified generative model 552.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a graphics processing unit (GPU) are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnected sets of transistors and memory elements) that can be configured (often on the fly) to perform customizable logic functions.

The device 1600 may include a memory 1686 and a CODEC 1634. The memory 1686 may include or correspond to the memory 106 or 706. The memory 1686 may include instructions 1656, that are executable by the one or more additional processors 1610 (or the processor 1606) to implement the functionality described with reference to the processor 1606 or 1610, the media generator 1680, or a combination thereof. The instructions 1656 may include or correspond to the instructions 109. The memory 1686 is also configured to store the generative model 130 and the adapter 138. Additionally, or alternatively, the memory 1686 may also include the modified generative model 150, 550, or 552, the adapter 138, 540, or 542, or a combination thereof. The device 1600 may include the modem 1670 coupled, via a transceiver 1650, to an antenna 1652. The modem 1670 may include or correspond to the modem 618.

The device 1600 may include a display 1628 coupled to a display controller 1626. The display 1628 may include or correspond to the display device 619 or a display of one of the devices of FIGS. 8-14. One or more speakers 1692, the microphone(s) 1694, or a combination thereof, may be coupled to the CODEC 1634. For example, the one or more speakers 1692 may include or correspond to the speaker 621 or a speaker of one or more of the devices of FIGS. 8-14. As another example, the one or more microphones 1694 may include or correspond to the input device 614 or a microphone of one or more of the devices of FIGS. 8-14. The CODEC 1634 may include a digital-to-analog converter (DAC) 1602, an analog-to-digital converter (ADC) 1604, or both. In a particular implementation, the CODEC 1634 may receive analog signals from the microphone(s) 1694, convert the analog signals to digital signals using the analog-to-digital converter 1604, and provide the digital signals to the speech and music codec 1608. In a particular implementation, the speech and music codec 1608 may provide digital signals to the CODEC 1634. The CODEC 1634 may convert the digital signals to analog signals using the digital-to-analog converter 1602 and may provide the analog signals to the speaker 1692.

In a particular implementation, the device 1600 may be included in a system-in-package or system-on-chip device 1622. For example, the system-in-package or system-on-chip device 1622 may include or correspond to the integrated circuit 702. In a particular implementation, the memory 1686, the processor 1606, the processors 1610, the display controller 1626, the CODEC 1634, and the modem 1670 are included in the system-in-package or system-on-chip device 1622. In a particular implementation, an input device 1630, a power supply 1644, and a camera 1645 are coupled to the system-in-package or the system-on-chip device 1622. For example, the input device 1630 may include or correspond to the input device 614, the display device 619, a microphone of one or more of the devices of FIGS. 8-14, or a display of one or more of the devices of FIGS. 8-14. As another example, the camera 1645 may include or correspond to the image sensor 604, the input device 614, or a camera of one or more of the devices of FIGS. 8-14. In some examples, the input device 1630 may include or be associated with the display device 619 or a display device of one or more of the devices of FIGS. 8-14. Moreover, in a particular implementation, as illustrated in FIG. 16, the display 1628, the input device 1630, the speaker(s) 1692, the microphone(s) 1694, the antenna 1652, the power supply 1644, and the camera 1645 are external to the system-in-package or the system-on-chip device 1622. In a particular implementation, each of the display 1628, the input device 1630, the speaker(s) 1692, the microphone(s) 1694, the antenna 1652, the power supply 1644, and the camera 1645 may be coupled to a component of the system-in-package or the system-on-chip device 1622, such as an interface or a controller.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining an input image frame. For example, the means for obtaining can include the system 100, the device 102, the memory 106, the processor 108, the media generator 120, the denoiser 122, the system 600, the device 602, the image sensor 604, the input device 614, the modem 618, the media generator 620, the encoder 630, the integrated circuit 702, the input interface 704, the processor 708, the memory 706, the mobile device 800, the camera 802, the wearable electronic device 900, the camera 902, the voice-controlled speaker system 1000, the camera 1002, the camera device 1100, the image sensor 1102, the headset 1200, the camera 1202, the glasses 1300, the camera 1302, the vehicle 1400, the camera 1402, the device 1600, the processor 1606, the processor(s) 1610, the system-in-package or the system-on-chip device 1622, the input device 1630, the camera 1645, the modem 1670, the media generator 1680, other circuitry configured to obtain the input image frame, or a combination thereof.

The apparatus also includes means for performing, for a first sampling operation of multiple sampling operations and based on the input image frame, a first portion of the first sampling operation via a first set of one or more layers of multiple layers of a generative model. For example, the means for performing the first portion of the first sampling operation can include the system 100, the device 102, the processor 108, the media generator 120, the denoiser 122, the system 600, the device 602, the media generator 620, the integrated circuit 702, the processor 708, the mobile device 800, the wearable electronic device 900, the voice-controlled speaker system 1000, the camera device 1100, the headset 1200, the glasses 1300, the vehicle 1400, the device 1600, the processor 1606, the processor(s) 1610, the system-in-package or the system-on-chip device 1622, the media generator 1680, other circuitry configured to perform the first portion of the first sampling operation, or a combination thereof. Additionally, the first set of one or more layers including a first layer associated with a first resolution.

The apparatus further includes means for performing, for a first sampling operation of multiple sampling operations and based on the input image frame, a second portion of the first sampling operation via an adapter. For example, the means for performing the second portion of the first sampling operation can include the system 100, the device 102, the processor 108, the media generator 120, the denoiser 122, the system 600, the device 602, the media generator 620, the integrated circuit 702, the processor 708, the mobile device 800, the wearable electronic device 900, the voice-controlled speaker system 1000, the camera device 1100, the headset 1200, the glasses 1300, the vehicle 1400, the device 1600, the processor 1606, the processor(s) 1610, the system-in-package or the system-on-chip device 1622, the media generator 1680, other circuitry configured to perform the second portion of the first sampling operation, or a combination thereof. Additionally, the adapter associated with a second resolution that is different from the first resolution.

The apparatus includes means for outputting, based on the multiple sampling operations, one or more output image frames. For example, the means for outputting can include the system 100, the device 102, the memory 106, the processor 108, the media generator 120, the denoiser 122, the system 600, the device 602, the modem 618, the display device 619, the speaker 621, the media generator 620, the decoder 632, the integrated circuit 702, the output interface 705, the processor 708, the mobile device 800, the display 804, the speaker 808, the wearable electronic device 900, the display 904, the speaker 908, the voice-controlled speaker system 1000, the display 1004, the speaker 1008, the camera device 1100, the display 1104, the speaker 1108, the headset 1200, the display 1204, the speaker 1208, the glasses 1300, the display 1304, the speaker 1308, the vehicle 1400, the display 1404, the speaker 1408, the device 1600, the processor 1606, the processor(s) 1610, the system-in-package or the system-on-chip device 1622, the display controller 1626, the display 1628, the modem 1670, the media generator 1680, the memory 1686, the speaker 1692, other circuitry configured to output the one or more output image frames, or a combination thereof.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to obtain an input image frame (e.g., the input image frame 140 or the latent representation frame 640). The instructions further cause the one or more processors to, for a first sampling operation of multiple sampling operations and based on the input image frame, perform a first portion of the first sampling operation via a first set of one or more layers of multiple layers (e.g., the multiple layers 132) of a generative model (e.g., the generative model 130). The first set of one or more layers includes a first layer (e.g., the first layer 134) associated with a first resolution. The instructions further cause the one or more processors to, for the first sampling operation of the multiple sampling operations and based on the input image frame, perform a second portion of the first sampling operation via an adapter (e.g., the adapter 138). The adapter is associated with a second resolution that is different from the first resolution. The instructions also cause the one or more processors to output, based on the multiple sampling operations, one or more output image frames (e.g., the output image frame 160 or the output latent representation frame 660).

Particular aspects of the disclosure are described below in sets of interrelated Examples:
According to Example 1, a device includes a memory configured to store: a generative model including multiple layers; and an adapter; and one or more processors configured to obtain an input image frame; for a first sampling operation of multiple sampling operations, perform, based on the input image frame: a first portion of the first sampling operation via a first set of one or more layers of the multiple layers of the generative model, the first set of one or more layers including a first layer associated with a first resolution; and a second portion of the first sampling operation via the adapter, the adapter associated with a second resolution that is different from the first resolution; and output, based on the multiple sampling operations, one or more output image frames.
Example 2 includes the device of Example 1, where the generative model includes an image-to-video generative model.
Example 3 includes the device of Example 1 or Example 2, where the generative model has a U-Net architecture.
Example 4 includes the device of any of Examples 1 to 3, where the adapter is configured to approximate operation of a second set of one or more layers of the multiple layers of the generative model.
Example 5 includes the device of any of Examples 1 to 4, where the one or more processors are configured to, for a second sampling operation of the multiple sampling operations, perform, based on the input image frame, perform the second sampling operations via the multiple layers of the generative model.
Example 6 includes the device of Example 5, where the one or more processors are configured to, for a third sampling operation of the multiple sampling operations, perform, based on the input image frame: a first portion of the third sampling operation via the first set of one or more layers of the multiple layers of the generative model; and a second portion of the third sampling operation via the adapter.
Example 7 includes the device of Example 6, where: the second sampling operation is performed after the first sampling operation; and the third sampling operation is performed after the second sampling operation.
Example 8 includes the device of any of Examples 5 to 7, where a first power consumption of performance of the first sampling stage is less than a second power consumption of performance of the second sampling stage.
Example 9 includes the device of any of Examples 5 to 8, where: the second sampling operation is performed prior to the first sampling operation; and the multiple layers of the generative model include the first layer associated with the first resolution and a second layer associated with the second resolution.
Example 10 includes the device of Example 9, where the adapter includes a first convolutional module configured to: receive a first feature output of the first layer for the first sampling operation, the first feature output associated with the first resolution; and receive a second feature output of the second layer for the second sampling operation, the second feature output associated with the second resolution.
Example 11 includes the device of Example 10, where the adapter includes one or more spatial-temporal modules coupled in series and configured to receive an output of the first convolution module.
Example 12 includes the device of Example 11, where the adapter includes a second convolutional module configured to: receive an output of the one or more spatial-temporal modules; and output a third feature output for the first sampling operation, the third feature output associated with the second resolution.
Example 13 includes the device of Example 12, where: at least one spatial-temporal module is configured to receive image embedding data output by an encoder; and each spatial-temporal module of the one or more spatial-temporal modules is configured to receive: time embedding data associate with the first sampling operation; and an image indicator that indicates the input image frame.
Example 14 includes the device of Example 12, where each spatial-temporal module of the one or more spatial-temporal modules include: a spatial residual network (resnet) configured to receive an input of the spatial-temporal module; a temporal resnet configured to receive a spatial output of the spatial resnet; and a blender module configured to receive the spatial output from the spatial resnet; receive a temporal output from the temporal resnet; and output a spatial-temporal output based on the spatial output and the temporal output.
Example 15 includes the device of any of Examples 1 to 14, where the one or more processors are configured to encode, via a variational autoencoder (VAE), the input image frame to generate a latent representation of the input image frame.
Example 16 includes the device of any of Examples 1 to 15, where the one or more output image frames include fourteen or more image frames associated with the input image frame.
Example 17 includes the device of any of Examples 1 to 16, where the generative model is applied to perform a text-based video generation, a text-based video content editing operation, image-based video generation, a video enhancement operation, video compression, a data augmentation operation, or a combination thereof.
Example 18 includes the device of any of Examples 1 to 17, and where the device further includes one or more cameras coupled to the one or more processors and configured to generate image data associated with the input image frame.
Example 19 includes the device of Example 18, and where the device further includes an input device configured to receive an input and provide the input to the one or more processors, where the input includes a request to generate video data including the one or more output image frames based on the image data from the one or more cameras.
Example 20 includes the device of any of Examples 1 to 17, and where the device further includes one or more cameras coupled to the one or more processors and configured to generate image data associated with the input image frame, where the one or more output image frames is generated by the one or more processors at least partially based on the image data from the one or more cameras.
Example 21 includes the device of Example 20, and where the device further includes a display device coupled to the one or more processors and configured to output the one or more output image frames as video content.
Example 22 includes the device of any of Examples 1 to 21, and where the device further includes a modem coupled to the one or more processors, the modem configured to transmit the one or more output image frames to a second device for output by the second device.
Example 23 includes the device of any of Examples 1 to 22, and where the device further includes a microphone configured to provide an input signal to the one or more processors to cause the one or more processors to generate the one or more output image frames.
Example 24 includes the device of any of Examples 1 to 23, and where the device further includes a speaker configured to output audio associated with the one or more output image frames.
Example 25 includes the device of any of Examples 1 to 24, where the one or more processors are integrated in at least one of a mobile phone, a tablet computer device, a wearable electronic device, a virtual reality headset, a mixed reality headset, an augmented reality headset, or a camera device.
According to Example 26, a method includes obtaining an input image frame; for a first sampling operation of multiple sampling operations, performing, based on the input image frame: a first portion of the first sampling operation via a first set of one or more layers of multiple layers of a generative model, the first set of one or more layers including a first layer associated with a first resolution; and a second portion of the first sampling operation via an adapter, the adapter associated with a second resolution that is different from the first resolution; and outputting, based on the multiple sampling operations, one or more output image frames.
Example 27 includes the method of Example 26, where the generative model includes an image-to-video generative model.
Example 28 includes the method of Example 26 or Example 27, where the generative model has a U-Net architecture.
Example 29 includes the method of any of Examples 26 to 28, where the adapter is configured to approximate operation of a second set of one or more layers of the multiple layers of the generative model.
Example 30 includes the method of any of Examples 26 to 29, and where the method includes, for a second sampling operation of the multiple sampling operations, performing, based on the input image frame, the second sampling operations via the multiple layers of the generative model.
Example 31 includes the method of Example 30, and where the method includes, for a third sampling operation of the multiple sampling operations, performing, based on the input image frame: a first portion of the third sampling operation via the first set of one or more layers of the multiple layers of the generative model; and a second portion of the third sampling operation via the adapter.
Example 32 includes the method of Example 31, where: the second sampling operation is performed after the first sampling operation; and the third sampling operation is performed after the second sampling operation.
Example 33 includes the method of any of Examples 30 to 32, where a first power consumption of performance of the first sampling stage is less than a second power consumption of performance of the second sampling stage.
Example 34 includes the method of any of Examples 30 to 33, where: the second sampling operation is performed prior to the first sampling operation; and the multiple layers of the generative model include the first layer associated with the first resolution and a second layer associated with the second resolution.
Example 35 includes the method of Example 34, where the adapter includes a first convolutional module configured to: receive a first feature output of the first layer for the first sampling operation, the first feature output associated with the first resolution; and receive a second feature output of the second layer for the second sampling operation, the second feature output associated with the second resolution.
Example 36 includes the method of Example 35, where the adapter includes one or more spatial-temporal modules coupled in series and configured to receive an output of the first convolution module.
Example 37 includes the method of Example 36, where the adapter includes a second convolutional module configured to: receive an output of the one or more spatial-temporal modules; and output a third feature output for the first sampling operation, the third feature output associated with the second resolution.
Example 38 includes the method of Example 37, where: at least one spatial-temporal module is configured to receive image embedding data output by an encoder; and each spatial-temporal module of the one or more spatial-temporal modules is configured to receive: time embedding data associate with the first sampling operation; and an image indicator that indicates the input image frame.
Example 39 includes the method of Example 37, where each spatial-temporal module of the one or more spatial-temporal modules include: a spatial residual network (resnet) configured to receive an input of the spatial-temporal module; a temporal resnet configured to receive a spatial output of the spatial resnet; and a blender module configured to receive the spatial output from the spatial resnet; receive a temporal output from the temporal resnet; and output a spatial-temporal output based on the spatial output and the temporal output.
Example 40 includes the method of any of Examples 26 to 39, and where the method includes encoding, via a variational autoencoder (VAE), the input image frame to generate a latent representation of the input image frame.
Example 41 includes the method of any of Examples 26 to 40, where the one or more output image frames include fourteen or more image frames associated with the input image frame.
Example 42 includes the method of any of Examples 26 to 41, where the generative model is applied to perform a text-based video generation, a text-based video content editing operation, image-based video generation, a video enhancement operation, video compression, a data augmentation operation, or a combination thereof.
Example 43 includes the method of any of Examples 26 to 42, and where the method includes generating, via one or more cameras, image data associated with the input image frame.
Example 44 includes the method of Example 43, and where the method includes receiving an input and providing the input to the one or more processors, where the input includes a request to generate video data including the one or more output image frames based on the image data from the one or more cameras.
Example 45 includes the method of any of Examples 26 to 42, and where the method includes generating, via one or more cameras, image data associated with the input image frame, where the one or more output image frames is generated by the one or more processors at least partially based on the image data from the one or more cameras.
Example 46 includes the method of Example 45, and where the method includes outputting, to a display device, the one or more output image frames as video content.
Example 47 includes the method of any of Examples 26 to 46, and where the method includes transmitting, via a modem, the one or more output image frames to a second device for output by the second device.
Example 48 includes the method of any of Examples 26 to 47, and where the method includes providing, via a microphone, an input signal to the one or more processors to cause the one or more processors to generate the one or more output image frames.
Example 49 includes the method of any of Examples 26 to 48, and where the method includes outputting, via a speaker, audio associated with the one or more output image frames.
Example 50 includes the method of any of Examples 26 to 49, where the method is performed by a device that includes a mobile phone, a tablet computer device, a wearable electronic device, a virtual reality headset, a mixed reality headset, an augmented reality headset, or a camera device.
According to Example 51, a non-transitory computer-readable medium that stores instructions that are executable by one or more processors to cause the one or more processors to obtain an input image frame; for a first sampling operation of multiple sampling operations, perform, based on the input image frame: a first portion of the first sampling operation via a first set of one or more layers of multiple layers of a generative model, the first set of one or more layers including a first layer associated with a first resolution; and a second portion of the first sampling operation via an adapter, the adapter associated with a second resolution that is different from the first resolution; and output, based on the multiple sampling operations, one or more output image frames.
Example 52 includes the non-transitory computer-readable medium of Example 51, where the generative model includes an image-to-video generative model.
Example 53 includes the non-transitory computer-readable medium of Example 51 or Example 52, where the generative model has a U-Net architecture.
Example 54 includes the non-transitory computer-readable medium of any of Examples 51 to 53, where the adapter is configured to approximate operation of a second set of one or more layers of the multiple layers of the generative model.
Example 55 includes the non-transitory computer-readable medium of any of Examples 51 to 54, where the instructions are further executable by the one or more processors to cause the one or more processors to, for a second sampling operation of the multiple sampling operations, perform, based on the input image frame, perform the second sampling operations via the multiple layers of the generative model.
Example 56 includes the non-transitory computer-readable medium of Example 55, where the instructions are further executable by the one or more processors to cause the one or more processors to, for a third sampling operation of the multiple sampling operations, perform, based on the input image frame: a first portion of the third sampling operation via the first set of one or more layers of the multiple layers of the generative model; and a second portion of the third sampling operation via the adapter.
Example 57 includes the non-transitory computer-readable medium of Example 56, where: the second sampling operation is performed after the first sampling operation; and the third sampling operation is performed after the second sampling operation.
Example 58 includes the non-transitory computer-readable medium of any of Examples 55 to 57, where a first power consumption of performance of the first sampling stage is less than a second power consumption of performance of the second sampling stage.
Example 59 includes the non-transitory computer-readable medium of any of Examples 55 to 58, where: the second sampling operation is performed prior to the first sampling operation; and the multiple layers of the generative model include the first layer associated with the first resolution and a second layer associated with the second resolution.
Example 60 includes the non-transitory computer-readable medium of Example 59, where the adapter includes a first convolutional module configured to: receive a first feature output of the first layer for the first sampling operation, the first feature output associated with the first resolution; and receive a second feature output of the second layer for the second sampling operation, the second feature output associated with the second resolution.
Example 61 includes the non-transitory computer-readable medium of Example 60, where the adapter includes one or more spatial-temporal modules coupled in series and configured to receive an output of the first convolution module.
Example 62 includes the non-transitory computer-readable medium of Example 61, where the adapter includes a second convolutional module configured to: receive an output of the one or more spatial-temporal modules; and output a third feature output for the first sampling operation, the third feature output associated with the second resolution.
Example 63 includes the non-transitory computer-readable medium of Example 62, where: at least one spatial-temporal module is configured to receive image embedding data output by an encoder; and each spatial-temporal module of the one or more spatial-temporal modules is configured to receive: time embedding data associate with the first sampling operation; and an image indicator that indicates the input image frame.
Example 64 includes the non-transitory computer-readable medium of Example 62, where each spatial-temporal module of the one or more spatial-temporal modules include: a spatial residual network (resnet) configured to receive an input of the spatial-temporal module; a temporal resnet configured to receive a spatial output of the spatial resnet; and a blender module configured to receive the spatial output from the spatial resnet; receive a temporal output from the temporal resnet; and output a spatial-temporal output based on the spatial output and the temporal output.
Example 65 includes the non-transitory computer-readable medium of any of Examples 51 to 64, where the instructions are further executable by the one or more processors to cause the one or more processors to encode, via a variational autoencoder (VAE), the input image frame to generate a latent representation of the input image frame.
Example 66 includes the non-transitory computer-readable medium of any of Examples 51 to 65, where the one or more output image frames include fourteen or more image frames associated with the input image frame.
Example 67 includes the non-transitory computer-readable medium of any of Examples 51 to 66, where the generative model is applied to perform a text-based video generation, a text-based video content editing operation, image-based video generation, a video enhancement operation, video compression, a data augmentation operation, or a combination thereof.
Example 68 includes the non-transitory computer-readable medium of any of Examples 51 to 67, wherein the instructions are further executable by the one or more processors to cause the one or more processors to receive, from one or more cameras, image data associated with the input image frame.
Example 69 includes the non-transitory computer-readable medium of Example 68, where the instructions are further executable by the one or more processors to cause the one or more processors to receive an input and provide the input to the one or more processors, and where the input includes a request to generate video data including the one or more output image frames based on the image data from the one or more cameras.
Example 70 includes the non-transitory computer-readable medium of any of Examples 51 to 67, where the instructions are further executable by the one or more processors to cause the one or more processors to receive, from one or more cameras, image data associated with the input image frame, and where the one or more output image frames is generated by the one or more processors at least partially based on the image data from the one or more cameras.
Example 71 includes the non-transitory computer-readable medium of Example 70, where the instructions are further executable by the one or more processors to cause the one or more processors to output, to a display device, the one or more output image frames as video content.
Example 72 includes the non-transitory computer-readable medium of any of Examples 51 to 71, where the instructions are further executable by the one or more processors to cause the one or more processors to transmit, via a modem, the one or more output image frames to a second device for output by the second device.
Example 73 includes the non-transitory computer-readable medium of any of Examples 51 to 72, where the instructions are further executable by the one or more processors to cause the one or more processors to receive, via a microphone, an input signal request generation of the one or more output image frames.
Example 74 includes the non-transitory computer-readable medium of any of Examples 51 to 73, where the instructions are further executable by the one or more processors to cause the one or more processors to output, via a speaker, audio associated with the one or more output image frames.
Example 75 includes the non-transitory computer-readable medium of any of Examples 51 to 74, where the one or more processors are integrated in at least one of a mobile phone, a tablet computer device, a wearable electronic device, a virtual reality headset, a mixed reality headset, an augmented reality headset, or a camera device.
According to Example 76, an apparatus includes means for obtaining an input image frame; means for performing, for a first sampling operation of multiple sampling operations and based on the input image frame, a first portion of the first sampling operation via a first set of one or more layers of multiple layers of a generative model, the first set of one or more layers including a first layer associated with a first resolution; and means for performing, for a first sampling operation of multiple sampling operations and based on the input image frame, a second portion of the first sampling operation via an adapter, the adapter associated with a second resolution that is different from the first resolution; and means for outputting, based on the multiple sampling operations, one or more output image frames.
Example 77 includes the apparatus of Example 76, where the generative model includes an image-to-video generative model.
Example 78 includes the apparatus of Example 76 or Example 77, where the generative model has a U-Net architecture.
Example 79 includes the apparatus of any of Examples 76 to 78, where the adapter is configured to approximate operation of a second set of one or more layers of the multiple layers of the generative model.
Example 80 includes the apparatus of any of Examples 76 to 79, and where the apparatus includes means for performing, for a second sampling operation of the multiple sampling operations and based on the input image frame, the second sampling operations via the multiple layers of the generative model.
Example 81 includes the apparatus of Example 80, and where the apparatus includes means for performing, for a third sampling operation of the multiple sampling operations and based on the input image frame: a first portion of the third sampling operation via the first set of one or more layers of the multiple layers of the generative model; and a second portion of the third sampling operation via the adapter.
Example 82 includes the apparatus of Example 81, where: the second sampling operation is performed after the first sampling operation; and the third sampling operation is performed after the second sampling operation.
Example 83 includes the apparatus of any of Examples 80 to 82, where a first power consumption of performance of the first sampling stage is less than a second power consumption of performance of the second sampling stage.
Example 84 includes the apparatus of any of Examples 80 to 83, where: the second sampling operation is performed prior to the first sampling operation; and the multiple layers of the generative model include the first layer associated with the first resolution and a second layer associated with the second resolution.
Example 85 includes the apparatus of Example 84, where the adapter includes a first convolutional module configured to: receive a first feature output of the first layer for the first sampling operation, the first feature output associated with the first resolution; and receive a second feature output of the second layer for the second sampling operation, the second feature output associated with the second resolution.
Example 86 includes the apparatus of Example 85, where the adapter includes one or more spatial-temporal modules coupled in series and configured to receive an output of the first convolution module.
Example 87 includes the apparatus of Example 86, where the adapter includes a second convolutional module configured to: receive an output of the one or more spatial-temporal modules; and output a third feature output for the first sampling operation, the third feature output associated with the second resolution.
Example 88 includes the apparatus of Example 87, where: at least one spatial-temporal module is configured to receive image embedding data output by an encoder; and each spatial-temporal module of the one or more spatial-temporal modules is configured to receive: time embedding data associate with the first sampling operation; and an image indicator that indicates the input image frame.
Example 89 includes the apparatus of Example 87, where each spatial-temporal module of the one or more spatial-temporal modules include: a spatial residual network (resnet) configured to receive an input of the spatial-temporal module; a temporal resnet configured to receive a spatial output of the spatial resnet; and a blender module configured to receive the spatial output from the spatial resnet; receive a temporal output from the temporal resnet; and output a spatial-temporal output based on the spatial output and the temporal output.
Example 90 includes the apparatus of any of Examples 76 to 89, and where the apparatus includes means for encoding the input image frame to generate a latent representation of the input image frame.
Example 91 includes the apparatus of any of Examples 76 to 90, where the one or more output image frames include fourteen or more image frames associated with the input image frame.
Example 92 includes the apparatus of any of Examples 76 to 91, where the generative model is applied to perform a text-based video generation, a text-based video content editing operation, image-based video generation, a video enhancement operation, video compression, a data augmentation operation, or a combination thereof.
Example 93 includes the apparatus of any of Examples 76 to 92, and where the apparatus includes means for generating image data associated with the input image frame.
Example 94 includes the apparatus of Example 93, and where the apparatus includes means for receiving an input that includes a request to generate video data including the one or more output image frames based on the image data.
Example 95 includes the apparatus of any of Examples 76 to 92, and where the apparatus includes means for generating image data associated with the input image frame, where the one or more output image frames is generated at least partially based on the image data.
Example 96 includes the apparatus of Example 95, and where the apparatus includes means for outputting, to a display device, the one or more output image frames as video content.
Example 97 includes the apparatus of any of Examples 76 to 96, and where the apparatus includes means for transmitting the one or more output image frames to a second device for output by the second device.
Example 98 includes the apparatus of any of Examples 76 to 97, and where the apparatus includes means for receiving an input signal to cause generation of the one or more output image frames.
Example 99 includes the apparatus of any of Examples 76 to 98, and where the apparatus includes means for outputting audio associated with the one or more output image frames.
Example 100 includes the apparatus of any of Examples 76 to 99, where the apparatus includes a mobile phone, a tablet computer device, a wearable electronic device, a virtual reality headset, a mixed reality headset, an augmented reality headset, or a camera device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store:
a generative model including multiple layers; and
an adapter; and
one or more processors configured to:
obtain an input image frame;
for a first sampling operation of multiple sampling operations, perform, based on the input image frame:
a first portion of the first sampling operation via a first set of one or more layers of the multiple layers of the generative model, the first set of one or more layers including a first layer associated with a first resolution; and
a second portion of the first sampling operation via the adapter, the adapter associated with a second resolution that is different from the first resolution; and
output, based on the multiple sampling operations, one or more output image frames.

2. The device of claim 1, wherein:
the generative model includes an image-to-video generative model;
the generative model has a U-Net architecture; or
a combination thereof.

3. The device of claim 1, wherein the adapter is configured to approximate operation of a second set of one or more layers of the multiple layers of the generative model.

4. The device of claim 1, wherein the one or more processors are configured to, for a second sampling operation of the multiple sampling operations, perform, based on the input image frame:
perform the second sampling operations via the multiple layers of the generative model.

5. The device of claim 4, wherein the one or more processors are configured to, for a third sampling operation of the multiple sampling operations, perform, based on the input image frame:
a first portion of the third sampling operation via the first set of one or more layers of the multiple layers of the generative model; and
a second portion of the third sampling operation via the adapter.

6. The device of claim 5, wherein:
the second sampling operation is performed after the first sampling operation; and
the third sampling operation is performed after the second sampling operation.

7. The device of claim 4, wherein a first power consumption of performance of the first sampling stage is less than a second power consumption of performance of the second sampling stage.

8. The device of claim 4, wherein:
the second sampling operation is performed prior to the first sampling operation; and
the multiple layers of the generative model include the first layer associated with the first resolution and a second layer associated with the second resolution.

9. The device of claim 8, wherein the adapter includes:
a first convolutional module configured to:
receive a first feature output of the first layer for the first sampling operation, the first feature output associated with the first resolution; and
receive a second feature output of the second layer for the second sampling operation, the second feature output associated with the second resolution;
one or more spatial-temporal modules coupled in series and configured to receive an output of the first convolution module; and
a second convolutional module configured to:
receive an output of the one or more spatial-temporal modules; and
output a third feature output for the first sampling operation, the third feature output associated with the second resolution.

10. The device of claim 9, wherein:
at least one spatial-temporal module is configured to receive image embedding data output by an encoder; and
each spatial-temporal module of the one or more spatial-temporal modules is configured to receive:
time embedding data associate with the first sampling operation; and
an image indicator that indicates the input image frame.

11. The device of claim 9, wherein each spatial-temporal module of the one or more spatial-temporal modules include:
a spatial residual network (resnet) configured to receive an input of the spatial-temporal module;
a temporal resnet configured to receive a spatial output of the spatial resnet; and
a blender module configured to:
receive the spatial output from the spatial resnet;
receive a temporal output from the temporal resnet; and
output a spatial-temporal output based on the spatial output and the temporal output.

12. The device of claim 1, wherein:
the one or more processors are configured to encode, via a variational autoencoder (VAE), the input image frame to generate a latent representation of the input image frame; and
wherein the one or more output image frames include fourteen or more image frames associated with the input image frame.

13. The device of claim 1, wherein the generative model is applied to perform a text-based video generation, a text-based video content editing operation, image-based video generation, a video enhancement operation, video compression, a data augmentation operation, or a combination thereof.

14. The device of claim 1, further comprising:
one or more cameras coupled to the one or more processors and configured to generate image data associated with the input image frame; and
an input device configured to receive an input and provide the input to the one or more processors, wherein the input includes a request to generate video data including the one or more output image frames based on the image data from the one or more cameras.

15. The device of claim 1, further comprising:
one or more cameras coupled to the one or more processors and configured to generate image data associated with the input image frame, wherein the one or more output image frames a is generated by the one or more processors at least partially based on the image data from the one or more cameras; and
a display device coupled to the one or more processors and configured to output the one or more output image frames as video content.

16. The device of claim 1, further comprising a modem coupled to the one or more processors, the modem configured to transmit the one or more output image frames to a second device for output by the second device.

17. The device of claim 1, further comprising:
a microphone configured to provide an input signal to the one or more processors to cause the one or more processors to generate the one or more output image frames;
a speaker configured to output audio associated with the one or more output image frames; or
a combination thereof.

18. The device of claim 1, wherein the one or more processors are integrated in at least one of a mobile phone, a tablet computer device, a wearable electronic device, a virtual reality headset, a mixed reality headset, an augmented reality headset, or a camera device.

19. A method of operating a device including a processor, the method comprising:
obtaining an input image frame;
for a first sampling operation of multiple sampling operations, performing, based on the input image frame:
a first portion of the first sampling operation via a first set of one or more layers of multiple layers of a generative model, the first set of one or more layers including a first layer associated with a first resolution; and
a second portion of the first sampling operation via an adapter, the adapter associated with a second resolution that is different from the first resolution; and
outputting, based on the multiple sampling operations, one or more output image frames.

20. A non-transitory computer-readable medium that stores instructions that are executable by one or more processors to cause the one or more processors to:
obtain an input image frame;
for a first sampling operation of multiple sampling operations, perform, based on the input image frame:
a first portion of the first sampling operation via a first set of one or more layers of multiple layers of a generative model, the first set of one or more layers including a first layer associated with a first resolution; and
a second portion of the first sampling operation via an adapter, the adapter associated with a second resolution that is different from the first resolution; and
output, based on the multiple sampling operations, one or more output image frames.
